(19) United States
(12) Patent Application Publication
(10) Pub. No.: US 2008/0145785 A1
(43) Pub. Date: Jun. 19, 2008

(54) Light sensitive planographic printing plate material

(75) Inventor: Emiko Kataoka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 12/001,438

(22) Filed: Dec. 11, 2007

(30) Foreign Application Priority Data
Dec. 18, 2006 (JP) JP2006-339701

(51) Int. Cl. G03C 1/00

(52) U.S. Cl. 430/281.1

(57) ABSTRACT

Disclosed is a light sensitive planographic printing plate material comprising a support and provided thereon, a light sensitive layer containing a photopolymerization initiator, a polymerizable ethylenically unsaturated compound, a sensitizing dye, a polymeric binder and a compound represented in formula 1,

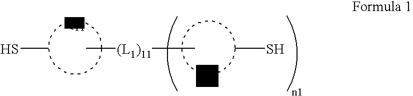

This application is based on Japanese Patent Application No. 2006-339701, filed on Dec. 18, 2006 in Japanese Patent Office, the entire content of which is hereby incorporated by reference.

### FIELD OF THE INVENTION

The present invention relates to a light sensitive planographic printing plate material for printing.

### BACKGROUND OF THE INVENTION

A light sensitive printing plate material capable of being imagewise exposed with laser having an emission wavelength from 390 to 430 nm is known, which improves a safelight property in view of handling. A compact blue-violet laser with high output power emitting 390 to 430 nm light can be easily obtained. A printing plate material adapted to this laser, which can be processed under room light, has been developed (see for example, Japanese Patent O.P.I. Publication Nos. 2000-35673, 2000-98605 and 2001-264978).

A printing plate material with improved safelight property under yellow light is known, which comprises a light sensitive layer containing a biimidazole compound (see for example, Japanese Patent O.P.I. Publication No. 2001-194782). Further, a polymerizable light sensitive composition with high sensitivity and low sublimation property is known which comprises a hexaarylbiimidazole having a substituted aryl group, e.g., an alkyl-substituted aryl group (see for example, Japanese Patent O.P.I. Publication No. 2004-137152).

It is known that distyryl benzene or a coumarin is used in a photopolymerizable light sensitive layer adapted to laser with a wavelength of from 350 to 450 nm (see for example, Japanese Patent O.P.I. Publication No. 2003-295426). Further, a combination of a heterocyclic mercapto compound with the above compound is disclosed in Japanese Patent O.P.I. Publication Nos. 2002-287342, 2003-114520 and 2006-91479.

However, these light sensitive printing plate materials have still problems in that sensitivity is insufficient, sensitivity variation after storage is great, contamination is produced at non-image portions or sludge is produced during development.

### SUMMARY OF THE INVENTION

The present invention has been made in view of the above. An object of the invention is to provide a light sensitive planographic printing plate material adapted to a laser emitting light with an emission wavelength of from 350 to 450 nm, and to provide a light sensitive planographic printing plate material which high sensitivity, excellent storage stability, high printing durability, minimized contaminations at non-image portions, and minimized sludge produced during development.

### DETAILED DESCRIPTION OF THE INVENTION

The object of the present invention can be attained by any one of the following constitutions.

1. A light sensitive planographic printing plate material comprising a support and provided thereon, a light sensitive layer containing a photopolymerization initiator, a polymerizable ethylenically unsaturated compound, a sensitizing dye, a polymeric binder and a compound represented by formula 1,

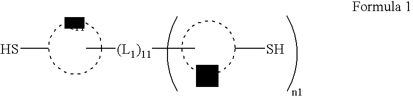

wherein Q₁₁ and Q₁₂ represent a non-metallic atomic group to form an unsaturated heterocyclic ring, provided that Q₁₁ and Q₁₂ may be the same or different; L₁ represents a divalent, trivalent or tetravalent linkage group; 11 is an integer of 0 or 1; and n1 is an integer of from 1 to 3.

2. The light sensitive planographic printing plate material of item 1 above, wherein the compound represented by formula 1 is a compound represented by formula 2,

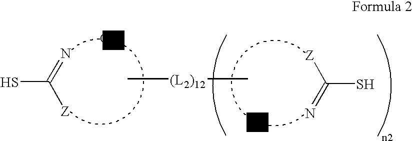

wherein Q₂₁ and Q₂₂ represent a non-metallic atomic group to form an unsaturated heterocyclic ring together with N═C—Z, provided that Q₂₁ and Q₂₂ may be the same or different; Z represents —CR₂₁═, —NR₂₂—, —S—, or —O—, in which R₂₁ and R₂₂ independently represent a hydrogen atom or a substituent; L₂ represents a divalent, trivalent or tetravalent linkage group; 12 is an integer of 0 or 1; and n2 is an integer of from 1 to 3.

3. The light sensitive planographic printing plate material of item 1 above, wherein the compound represented by formula 1 is a compound represented by formula 3,

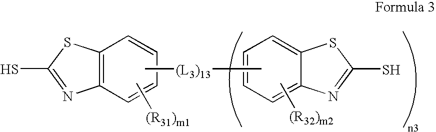

wherein R₃₁ and R₃₂ represent a substituent; m1 and m2 independently represent an integer of from 0 to 3; L₃ represents a divalent, trivalent or tetravalent linkage group; 13 is an integer of 0 or 1; and n3 is an integer of from 1 to 3.
4. The light sensitive planographic printing plate material of any one of items 1 through 3 above, wherein the sensitizing dye has a coumarin moiety, an acridone moiety or a styryl moiety as the molecular nucleus.

5. The light sensitive planographic printing plate material of any one of items 1 through 4 above, wherein the polymerization initiator includes a hexaarylbiimidazole compound.

6. The light sensitive planographic printing plate material of any one of items 1 through 5 above, wherein the polymerizable ethylenically unsaturated compound is a reaction product of Compounds (C1), (C2) and (C3), Compound (C1) being a compound having in the molecule at least one ethylenic double bond and one hydroxyl group, Compound (C2) being a diisocyanate compound, and Compound (C3) being a diol compound having in the molecule a tertiary amino group or a compound having in the molecule one secondary amino group and one hydroxyl group.

7. The light sensitive planographic printing plate material of any one of items 1 through 6 above, wherein the polymerizable ethylenically unsaturated compound is a compound represented by formula 4,

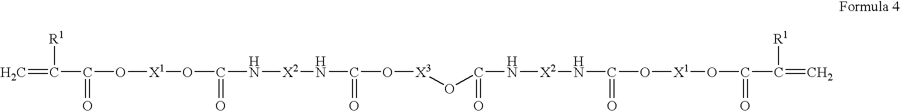

wherein R¹ represents a hydrogen atom or a methyl group; X¹ represents a divalent aliphatic hydrocarbon group; X² represents a divalent hydrocarbon radical containing an aromatic ring; and X³ represents a divalent linkage group containing a tertiary amino group.

8. The light sensitive planographic printing plate material of items 1 through 7 above, wherein the content of the compound represented by formula 1 in the light sensitive layer is from 0.01 to 20% by weight, based on the total solid content of light sensitive layer.

9. The light sensitive planographic printing plate material of items 1 through 7 above, wherein the content of the compound represented by formula 1 in the light sensitive layer is from 0.05 to 10% by weight, based on the total solid content of light sensitive layer.

The present inventor has made an extensive study. As a result, the present inventor has found that in a light sensitive planographic printing plate material comprising a support and provided thereon, a light sensitive layer containing a polymerization initiator, a polymerizable ethylenically unsaturated compound, a sensitizing agent and a polymeric binder, use of a compound represented by formula 1 provides a light sensitive planographic printing plate material which is adapted to a laser emitting light with an emission wavelength of from 350 to 450 nm, and which provides high sensitivity, excellent storage stability, high printing durability, and minimizes contaminations at non-image portions and sludge produced during development, and completed the invention.

The present invention will be explained in detail below.

### (Compound Represented by Formula 1)

The present invention is characterized in that the light sensitive layer contains a compound represented by formula 1.

In formula 1 above, Q₁₁ and Q₁₂ represent a non-metallic atomic group to form an unsaturated heterocyclic ring, provided that Q₁₁ and Q₁₂ may be the same or different; L₁ represents a divalent, trivalent or tetravalent linkage group; 11 is an integer of 0 or 1; and n1 is an integer of from 1 to 3.

Examples of the unsaturated heterocyclic ring Q₁₁ or Q₁₂ include a triazole ring, a tetrazole ring, a pyrazole ring, an imidazole ring, a thiazole ring, an isothiazole ring, an oxazole ring, an isoxazole ring, a thidiazole ring, an oxadiazole ring, a triazine ring, a pyrrole ring, a thiophene ring, a furan ring, a thiadiazine ring, a pyridine ring, a pyrazine ring, a pyrimidine ring, and a pyridazine ring. These unsaturated heterocyclic rings may form a condensed ring together with an aryl group or another unsaturated heterocyclic ring, and may have further a substituent.

Examples of the substituent include an alkyl group (for example, methyl, ethyl, isopropyl, hydroxyethyl, stearyl, dodecyl, eicosyl, docosyl or oleyl), a cycloalkyl group (for example, cyclopropyl or cyclohexyl), an aryl group (for example, phenyl, p-tetradecanyloxyphenyl, o-octadecanylaminophenyl, naphthyl or hydroxyphenyl), a hydroxyl group, a carboxyl group, a nitro group, a trifluoromethyl group, an amido group (for example, acetamido or benzamido), a carbamoyl group (for example, methylcarbamoyl, butylcarbamoyl or phenylcarbamoyl), an alkyloxycarbonyl group (for example, ethyloxycarbonyl or isopropyloxycarbonyl), an aryloxycarbonyl group (for example, phenyloxycarbonyl), a carbonyloxy group (for example, methylcarbonyloxy, propylcarbonyloxy or phenylcarbonyloxy), a cyano group, a halogen atom (for example, chlorine, bromine, iodine or fluorine), an alkoxy group (for example, methoxy, ethoxy or butoxy), an aryloxy group (for example, phenoxy), a sulfonyl group (for example, methanesulfonyl or p-toluenesulfonyl), an alkylthio group (for example, methylthio, ethylthio or butylthio), an arylthio group (for example, phenylthio), a sulfonamido group (for example, methanesulfonamido, dodecylsulfonamido or p-toluenesulfonamido), a sulfamoyl group (for example, methylsulfamoyl or phenylsulfamoyl), an amino group, and an alkylamino group (for example, ethylamino, diethylamino or hydroxyethylamino).

Q₁₁ and Q₁₂ may be the same or different. When n1 is 2 or 3, the plural Q₁₂S may be the same or different. L₁ represents a divalent, trivalent or tetravalent linkage group. Examples thereof include an alkylene group (for example, methylene, ethylene, 2,2-dimethylpropylene, propylene, 1,4-cyclohexylene, dodecylene, hexadecylene, 2-ethylhexylene, or 2-hexyldecylene), an arylene group (for example, phenylene or naphthylene), —C(═O)—, —SO₂—, —O—, —S—, —NR₁₁— (in which R₁₁ represents a hydrogen atom, an alkyl group or an aryl group) or their combination, and an radical as listed below.

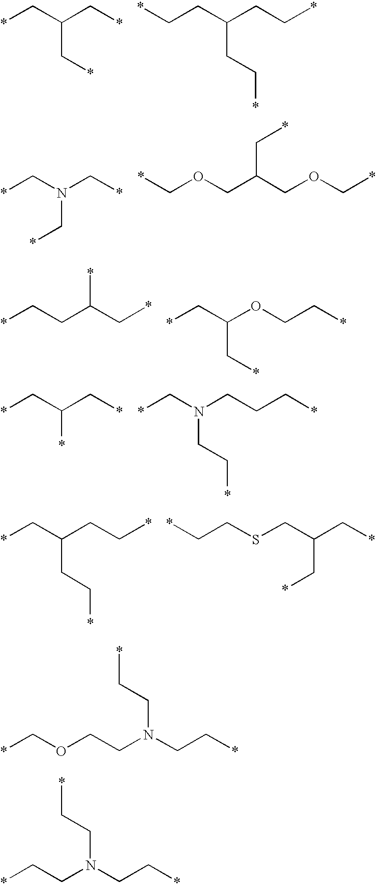

In the above radicals, asterisk “*” represents a linkage site at which the radicals combine with Q₁₁ and Q_{12.}

### (Compound Represented by Formula 2)

In formula 2 above, Q₂₁ and Q₂₂ represent a non-metallic atomic group to form an unsaturated heterocyclic ring together with N═C—Z, provided that Q₂₁ and Q₂₂ may be the same or different; Z represents —CR₂₁═, —NR₂₂—, —S—, or —O—, in which R₂₁ and R₂₂ independently represent a hydrogen atom or a substituent; L₂ represents a divalent, trivalent or tetravalent linkage group; 12 is an integer of 0 or 1; and n2 is an integer of from 1 to 3.

Examples of the unsaturated heterocyclic ring containing Q₂₁ or Q₂₂ include a triazole ring, a tetrazole ring, a pyrazole ring, an imidazole ring, a thiazole ring, an isothiazole ring, an oxazole ring, an isoxazole ring, a thidiazole ring, an oxadiazole ring, a triazine ring, a pyrrole ring, a thiadiazine ring, a pyridine ring, a pyrazine ring, a pyrimidine ring, and a pyridazine ring. The mercapto group is located at an a position relative to —N═. These unsaturated heterocyclic rings may form a condensed ring together with an aryl group or another unsaturated heterocyclic ring, and may have further a substituent. Examples of the substituent include an alkyl group (for example, methyl, ethyl, isopropyl, hydroxyethyl, stearyl, dodecyl, eicosyl, docosyl or oleyl), a cycloalkyl group (for example, cyclopropyl or cyclohexyl), an aryl group (for example, phenyl, p-tetradecanyloxyphenyl, o-octadecanylaminophenyl, naphthyl or hydroxyphenyl), a hydroxyl group, a carboxyl group, a nitro group, a trifluoromethyl group, an amido group (for example, acetamido or benzamido), a carbamoyl group (for example, methylcarbamoyl, butylcarbamoyl or phenylcarbamoyl), an alkyloxycarbonyl group (for example, ethyloxycarbonyl or isopropyloxycarbonyl), an aryloxycarbonyl group (for example, a phenyloxycarbonyl group), a carbonyloxy group (for example, methylcarbonyloxy, propylcarbonyloxy or phenylcarbonyloxy), a cyano group, a halogen atom (for example, chlorine, bromine, iodine or fluorine), an alkoxy group (for example, methoxy, ethoxy or butoxy), an aryloxy group (for example, phenoxy), a sulfonyl group (for example, methanesulfonyl or p-toluenesulfonyl), an alkylthio group (for example,methylthio, ethylthio or butylthio), an arylthio group (for example, phenylthio), a sulfonamido group (for example, methanesulfonamido, dodecylsulfonamido or p-toluenesulfonamido), a sulfamoyl group (for example, methylsulfamoyl or phenylsulfamoyl), an amino group, and an alkylamino group (for example, ethylamino, diethylamino or hydroxyethylamino). The unsaturated heterocyclic ring formed by Q₂₁ and N═C—Z or Q₂₂ and N═C—Z may be the same or different. When n2 is 2. or 3, the plural unsaturated heterocyclic rings formed by Q₂₂ and N═C—Z may be the same or different. Z represents —CR₂₁═, —NR₂₂—, —S═, or —O—, in which R₂₁ and R₂₂ independently represent a hydrogen atom, or a substituent. Examples of the substituent include an alkyl group (for example, methyl, ethyl, isopropyl, hydroxyethyl, stearyl, dodecyl, eicosyl, docosyl or oleyl), a cycloalkyl group (for example, cyclopropyl or cyclohexyl), an aryl group (for example, phenyl, p-tetradecanyloxyphenyl, o-octadecanylaminophenyl, naphthyl or hydroxyphenyl). L₂ represents the same as those denoted above in L₁ of formula 1 above.

### (Compound Represented by Formula 3)

In formula 3 above, R₃₁ and R₃₂ represent a substituent; m1 and m2 independently represent an integer of from 0 to 3; L₃ represents a divalent, trivalent or tetravalent linkage group; 13 is an integer of 0 or 1; and n3 is an integer of from 1 to 3.

In formula 3, examples of the substituent represented by R₃₁ or R₃₂ include an alkyl group (for example, methyl, ethyl, isopropyl, hydroxyethyl, stearyl, dodecyl, eicosyl, docosyl or oleyl), a cycloalkyl group (for example, cyclopropyl or cyclohexyl), an aryl group (for example, phenyl, p-tetradecanyloxyphenyl, o-octadecanylaminophenyl, naphthyl or hydroxyphenyl), a hydroxyl group, a carboxyl group, a nitro group, a trifluoromethyl group, an amido group (for example, acetamido or benzamido), a carbamoyl group (for example, methylcarbamoyl, butylcarbamoyl or phenylcarbamoyl), an alkyloxycarbonyl group (for example, ethyloxycarbonyl or isopropyloxycarbonyl), an aryloxycarbonyl group (for example, a phenyloxycarbonyl group), a carbonyloxy group (for example, methylcarbonyloxy, propylcarbonyloxy or phenylcarbonyloxy), a cyano group, a halogen atom (for example, chlorine, bromine, iodine or fluorine), an alkoxy group (for example, methoxy, ethoxy or butoxy), an aryloxy group (for example, phenoxy), a sulfonyl group (for example, methanesulfonyl or p-toluenesulfonyl), an alkylthio group (for example, methylthio, ethylthio or butylthio), an arylthio group (for example, phenylthio), a sulfonamido group (for example, methanesulfonamido, dodecylsulfonamido or p-toluenesulfonamido), a sulfamoyl group (for example, methylsulfamoyl or phenylsulfamoyl), an amino group, and an alkylamino group (for example, ethylamino, diethylamino or hydroxyetylamino). L₃ represents the same as those denoted above in L₁ of formula 1 above.

Examples of a compound represented by formula 1, 2, or 3 will be listed below, but the invention is not limited thereto.

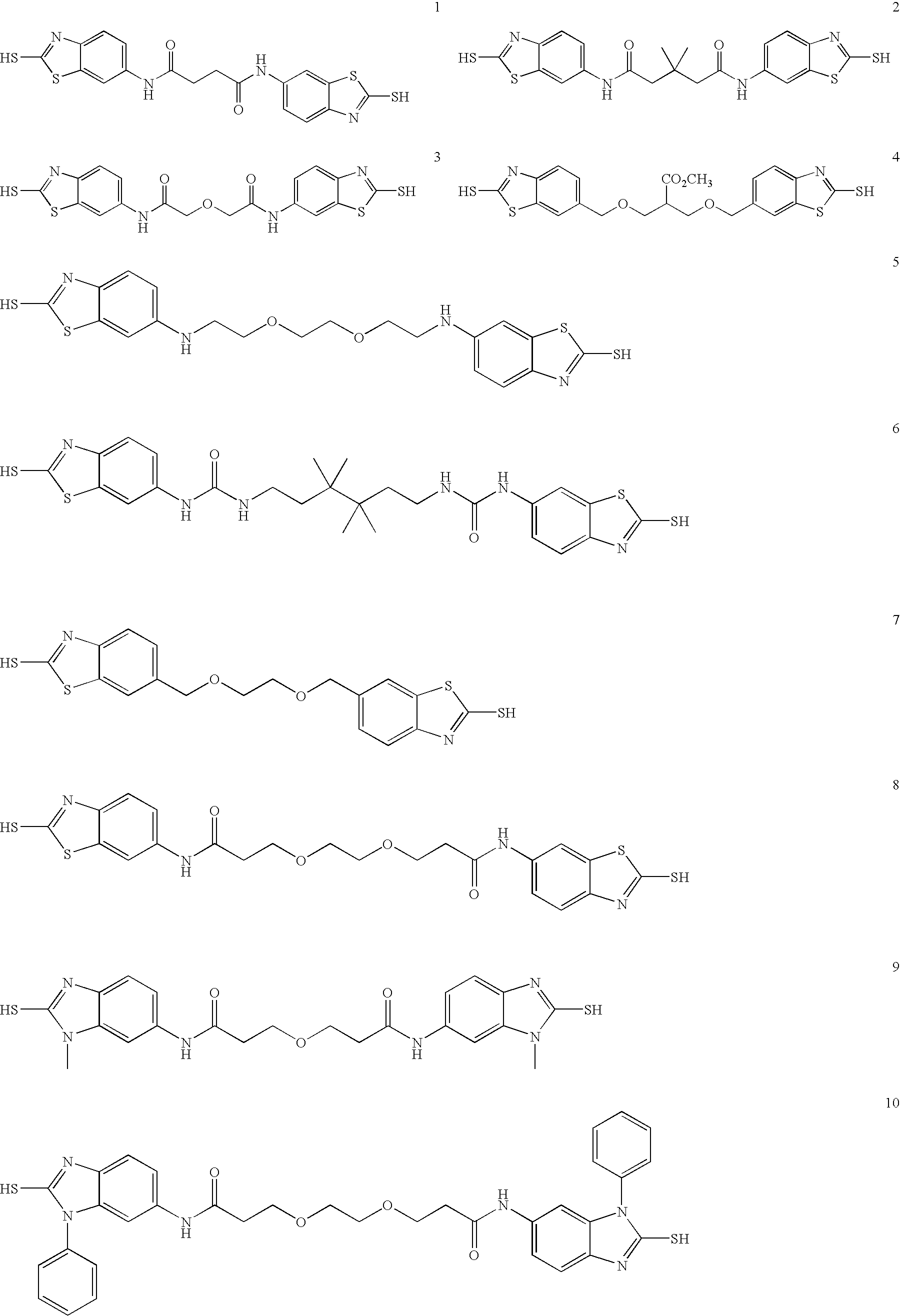

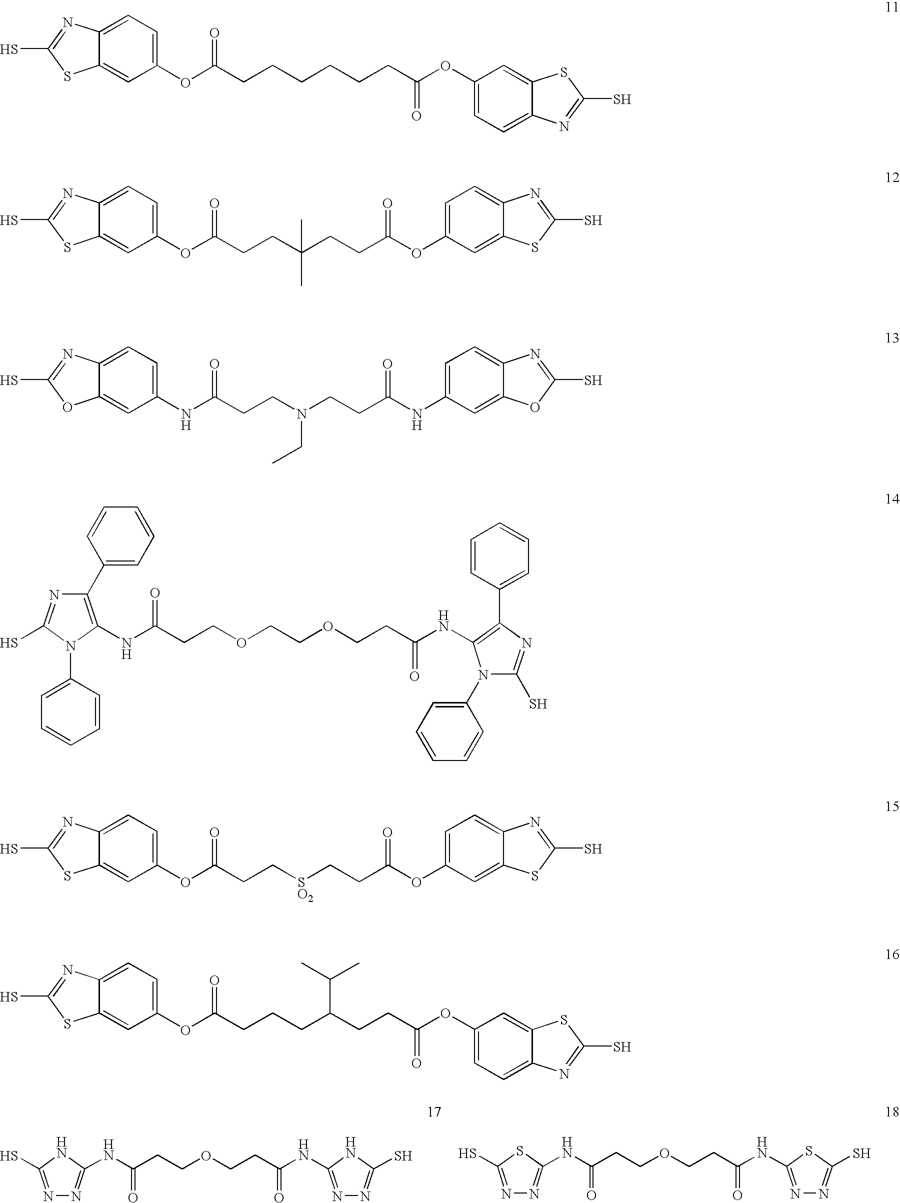

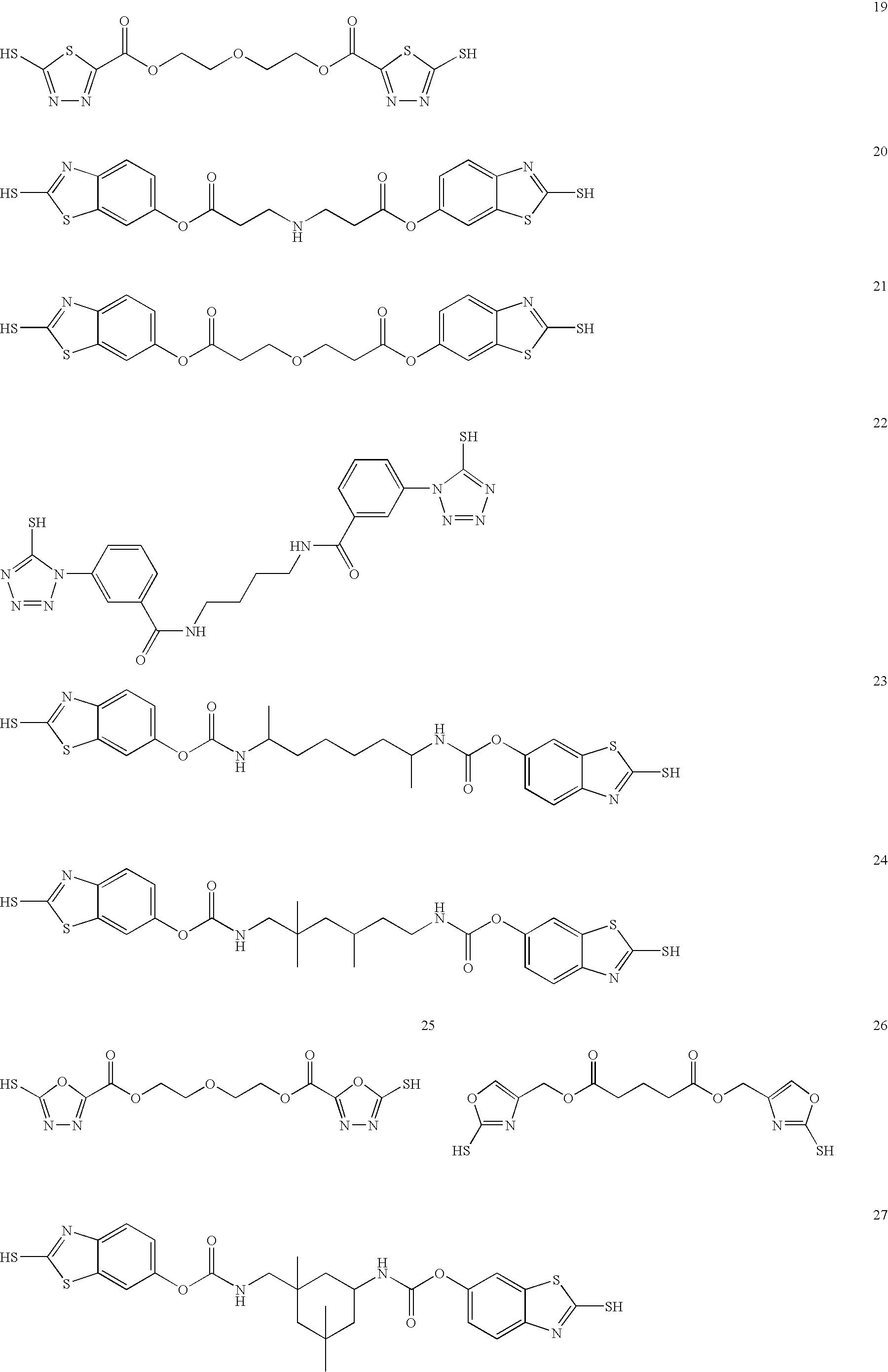

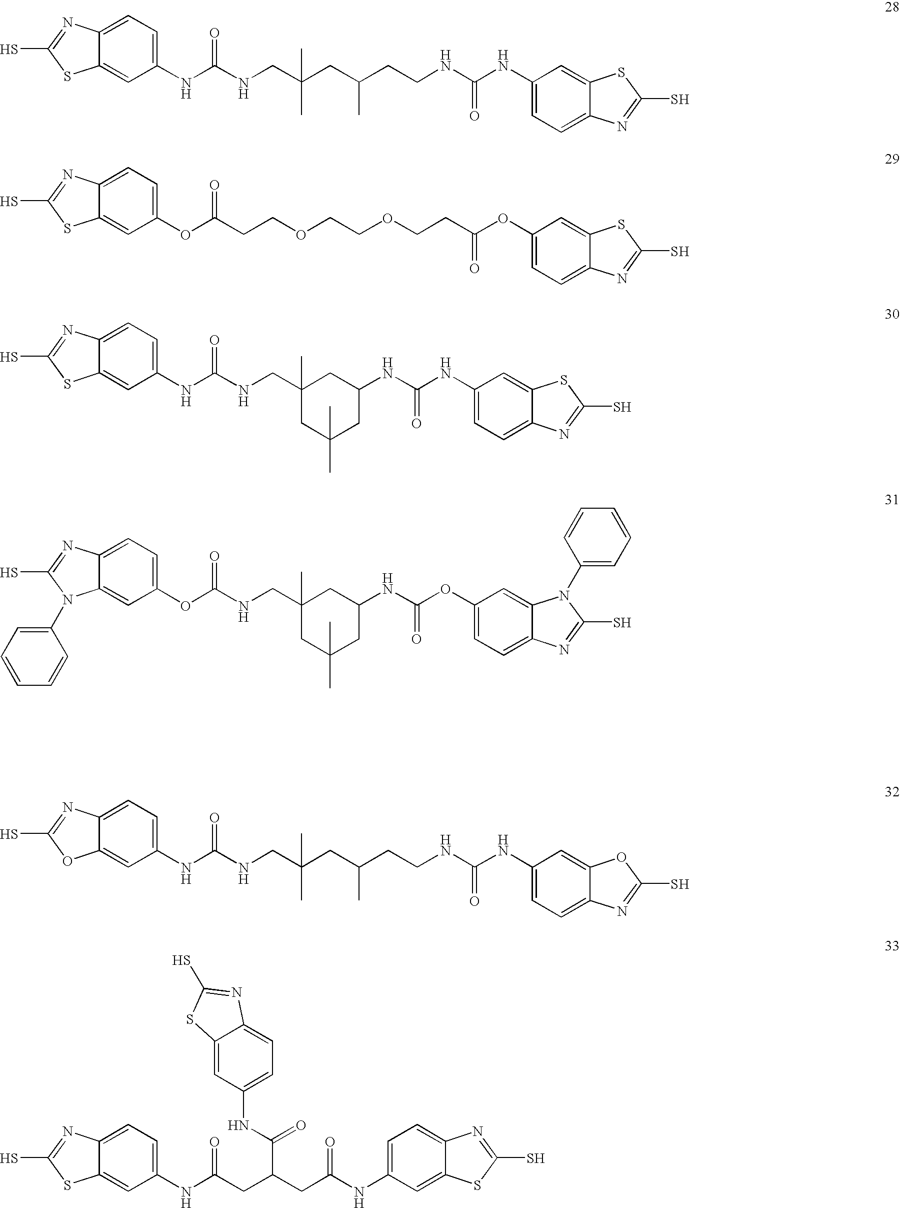

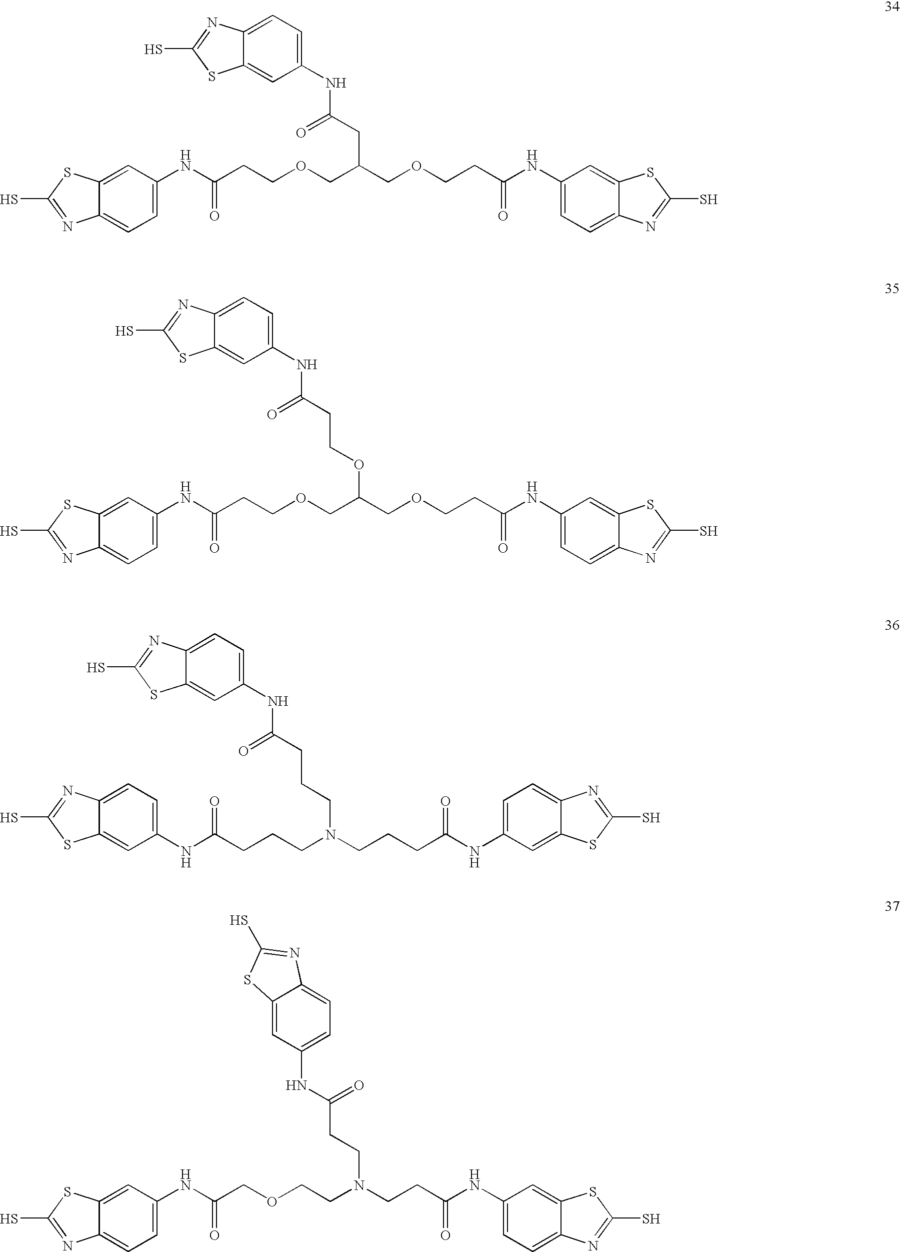

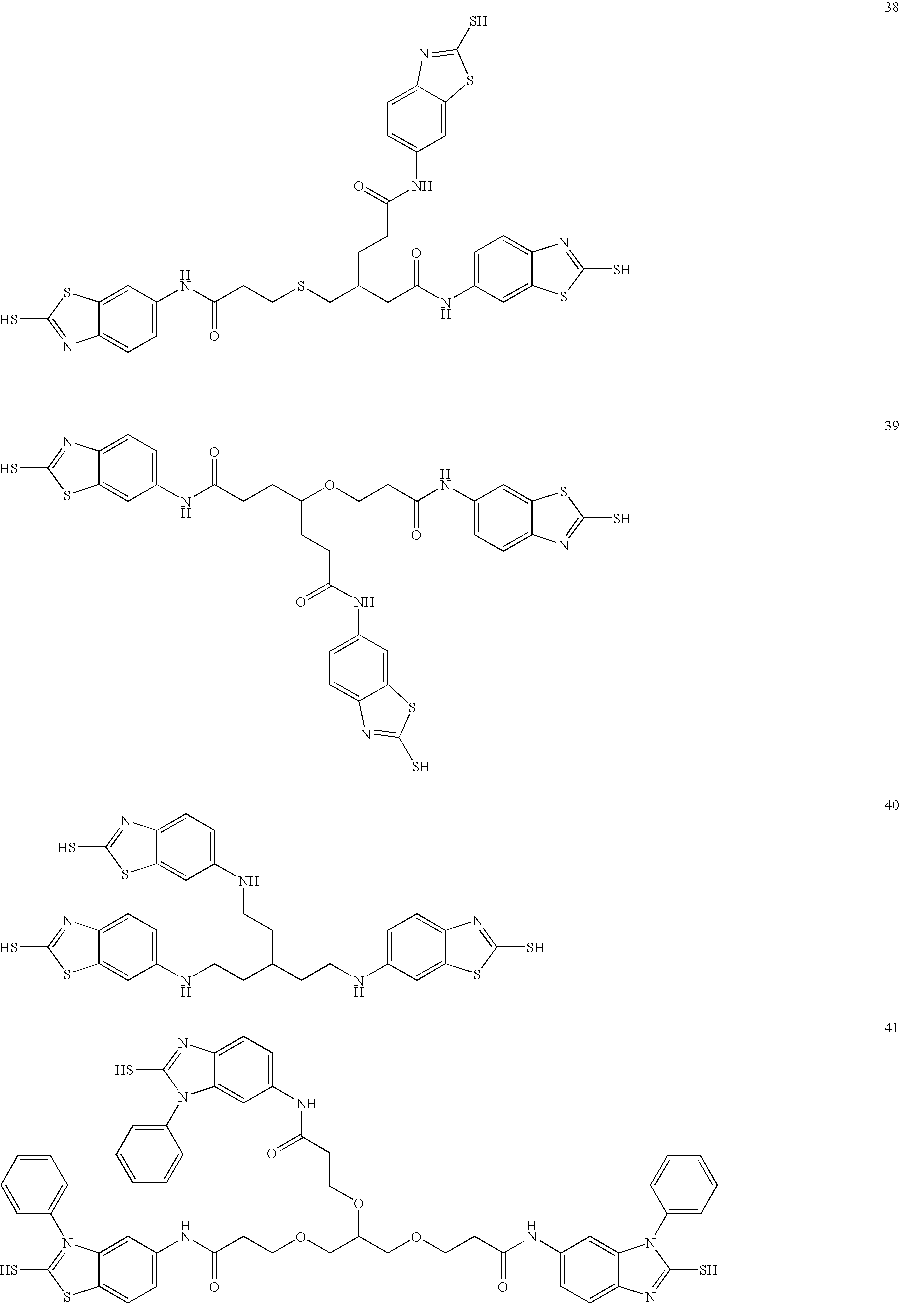

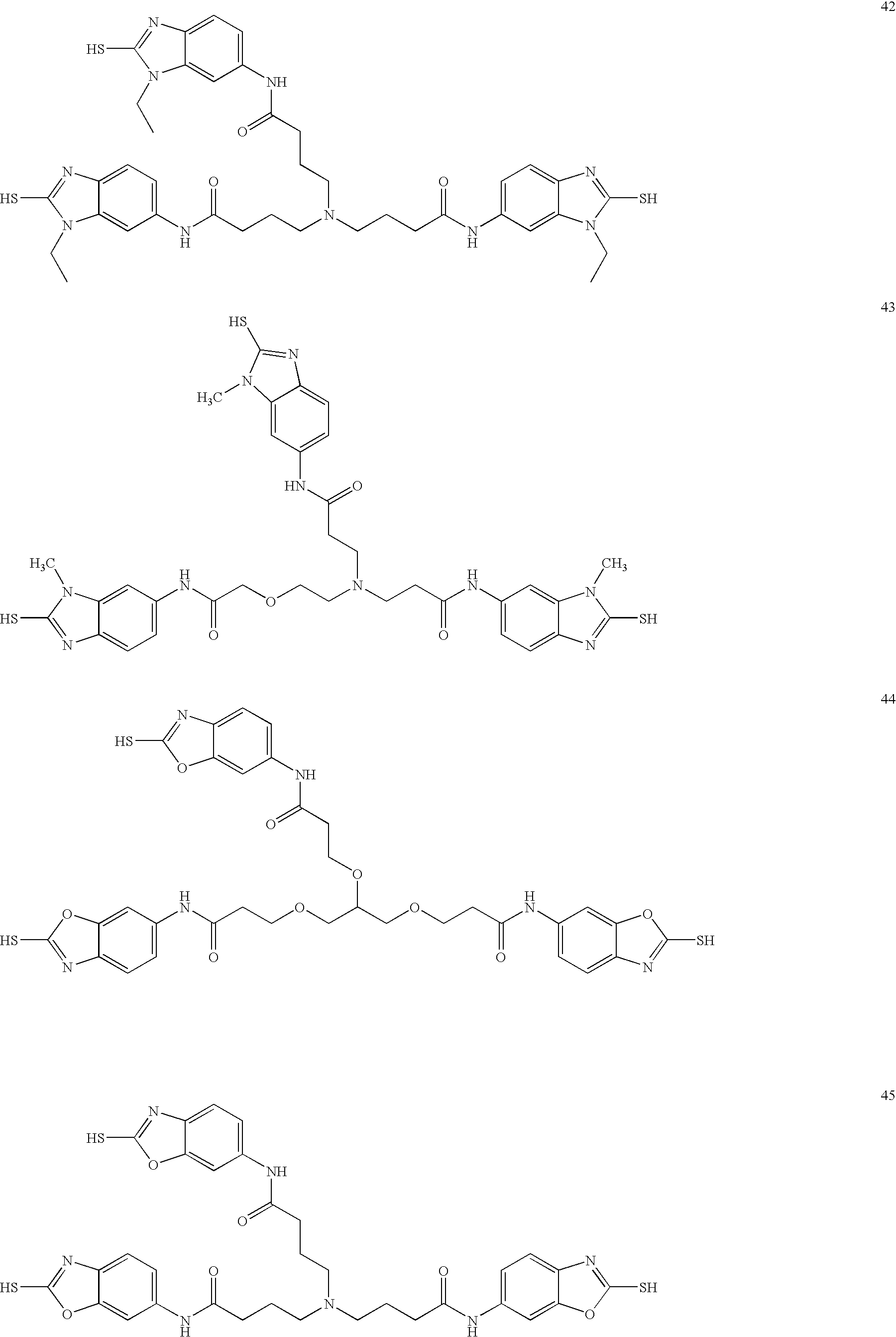

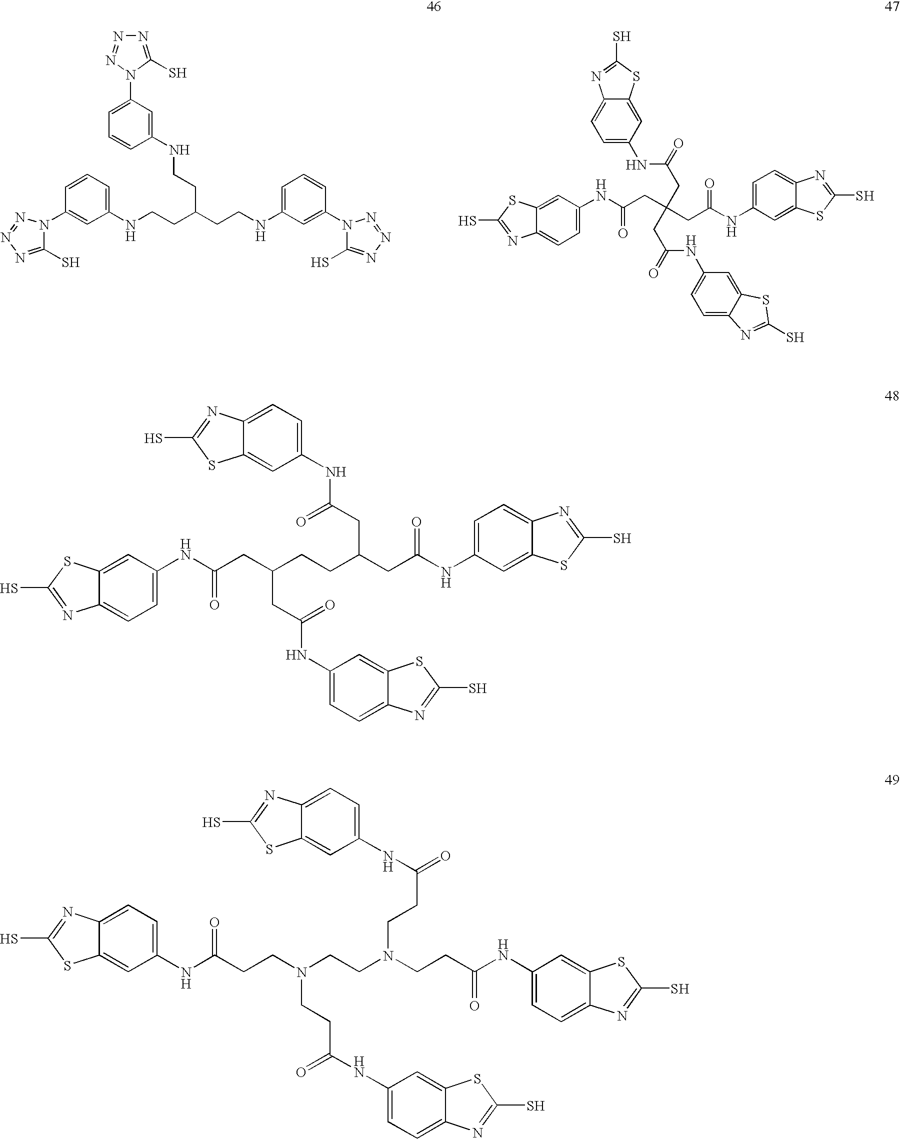

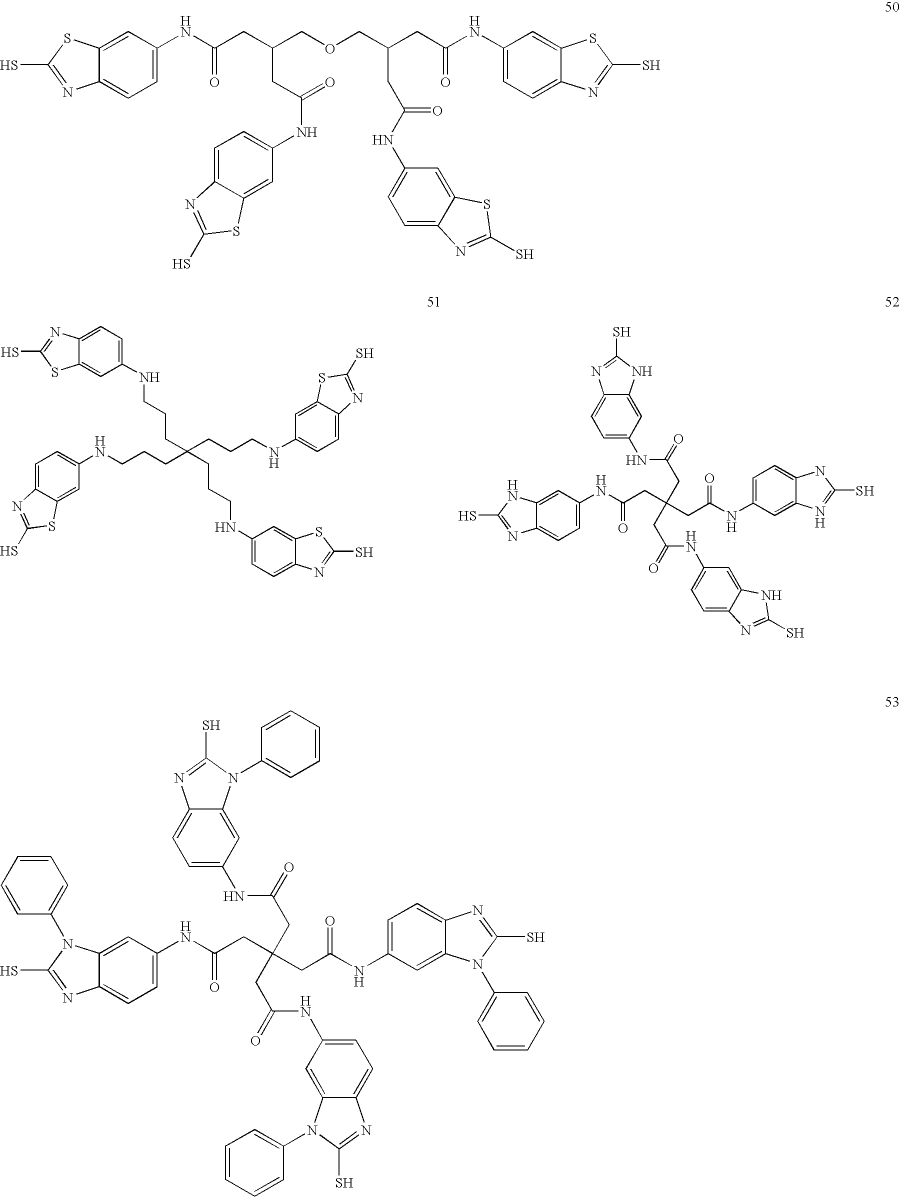

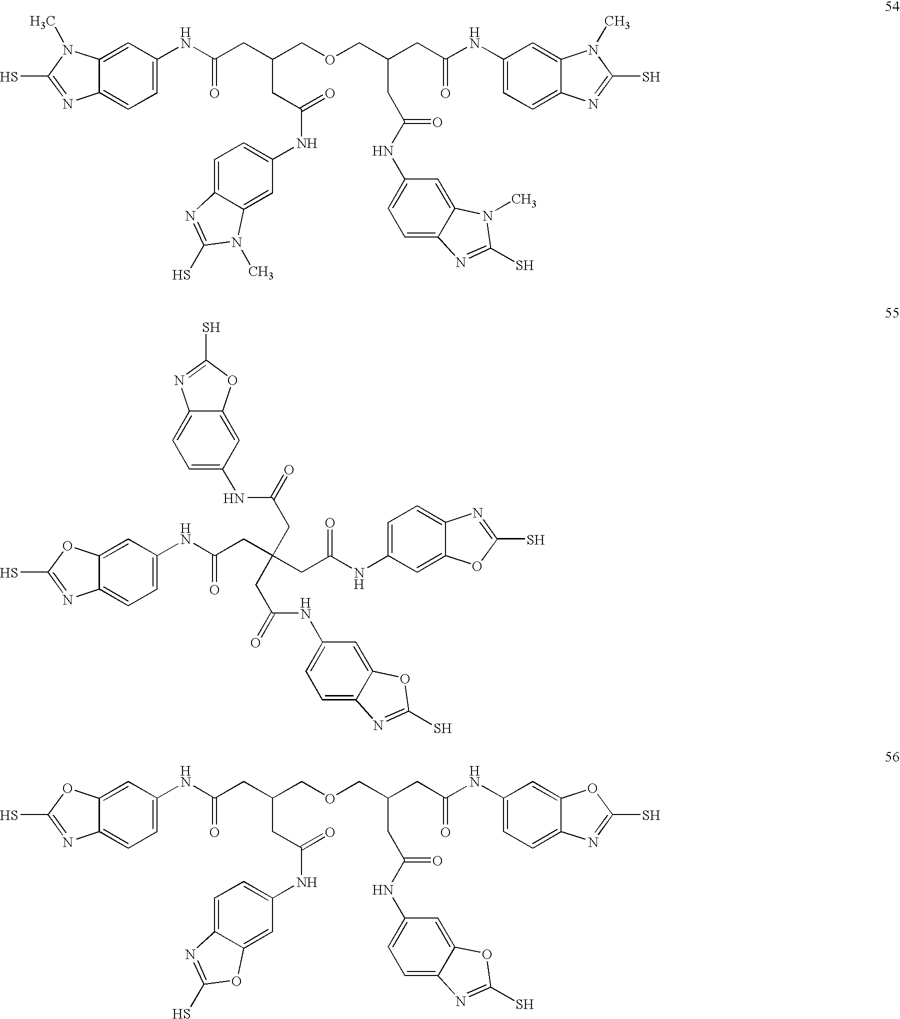

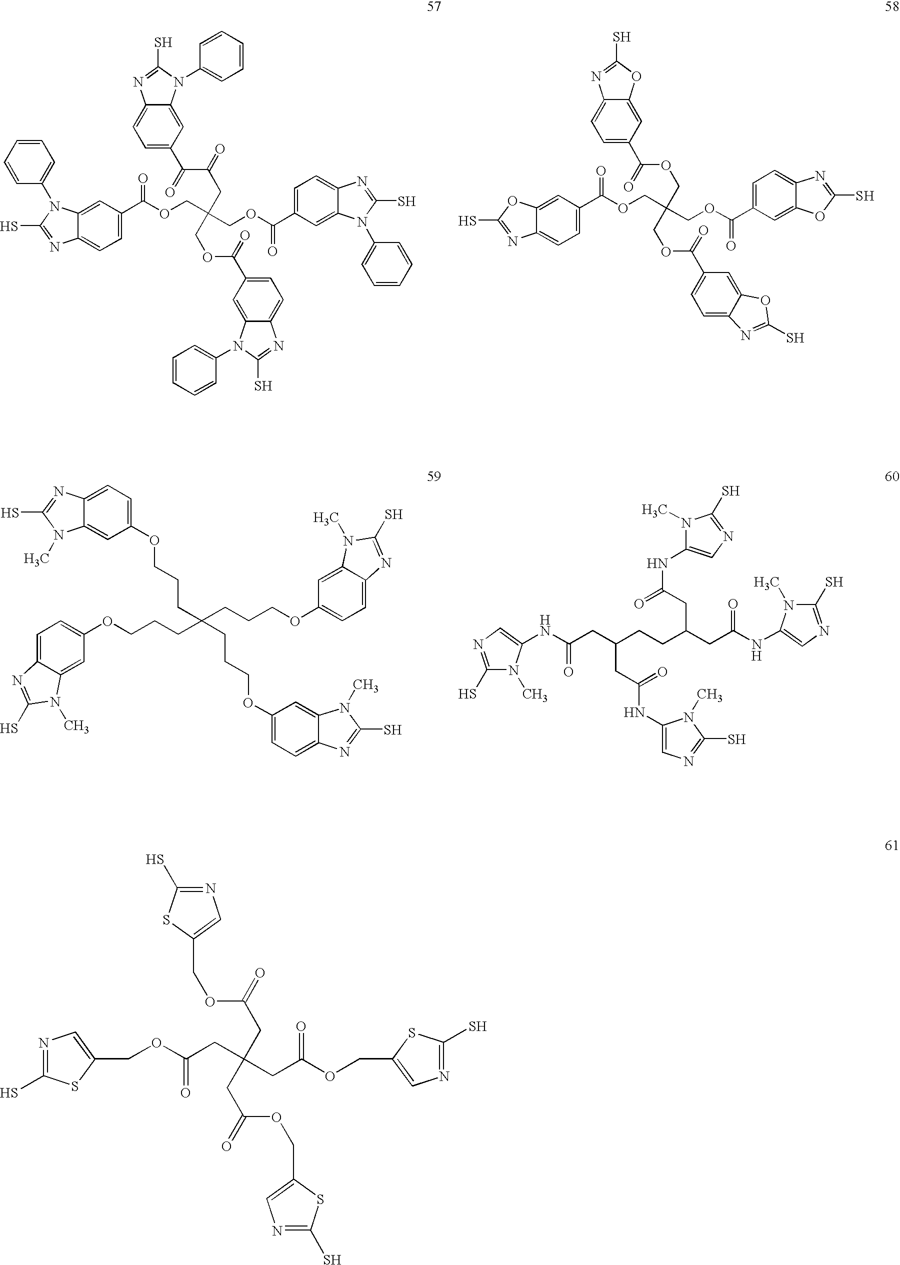

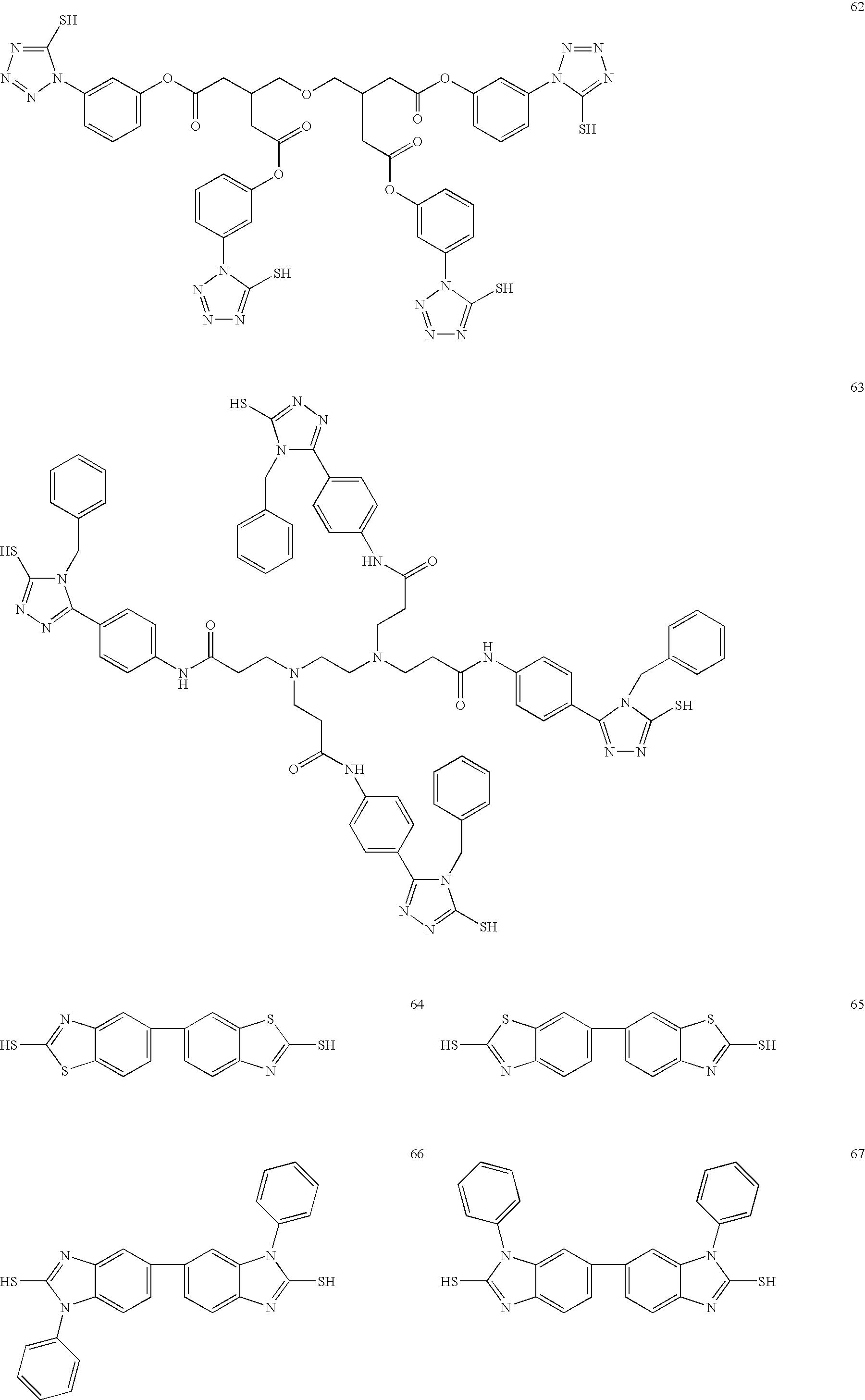

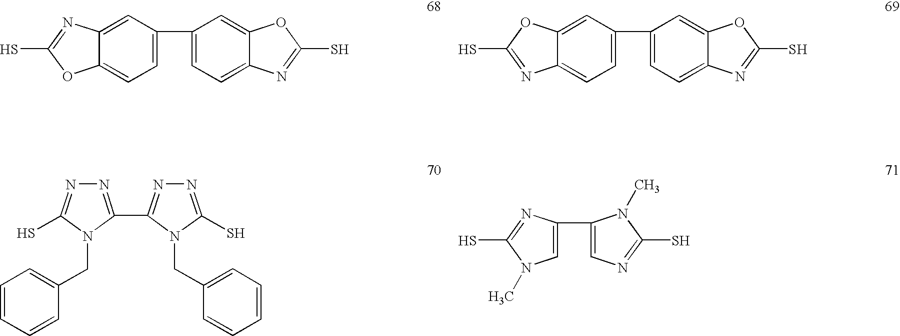

### [Sensitizing Dye]

The sensitizing dye used in the invention is not specifically limited, as long as it has absorption maximum in the wavelength range of from 350 to 450 nm. The sensitizing dye is preferably a sensitizing dye having a coumarin moiety, an acridone moiety or a styryl moiety as the molecular nucleus, and more preferably a sensitizing dye having an acridone moiety as the molecular nucleus. Examples of the coumarin, acridone or styryl moiety as the molecular nucleus include the nuclei as shown below, and these nuclei may have a substituent.

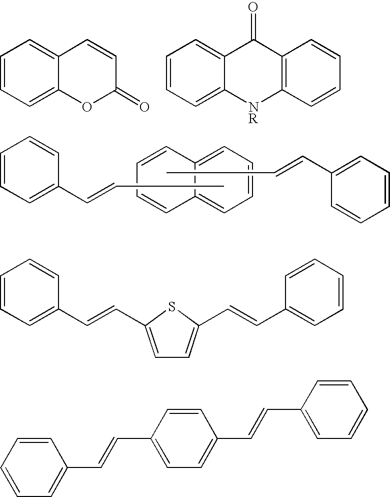

Examples of the sensitizing dye having a coumarin moiety, an acridone moiety or a styryl moiety as the molecular nucleus will be listed below, but the invention is not limited thereto.

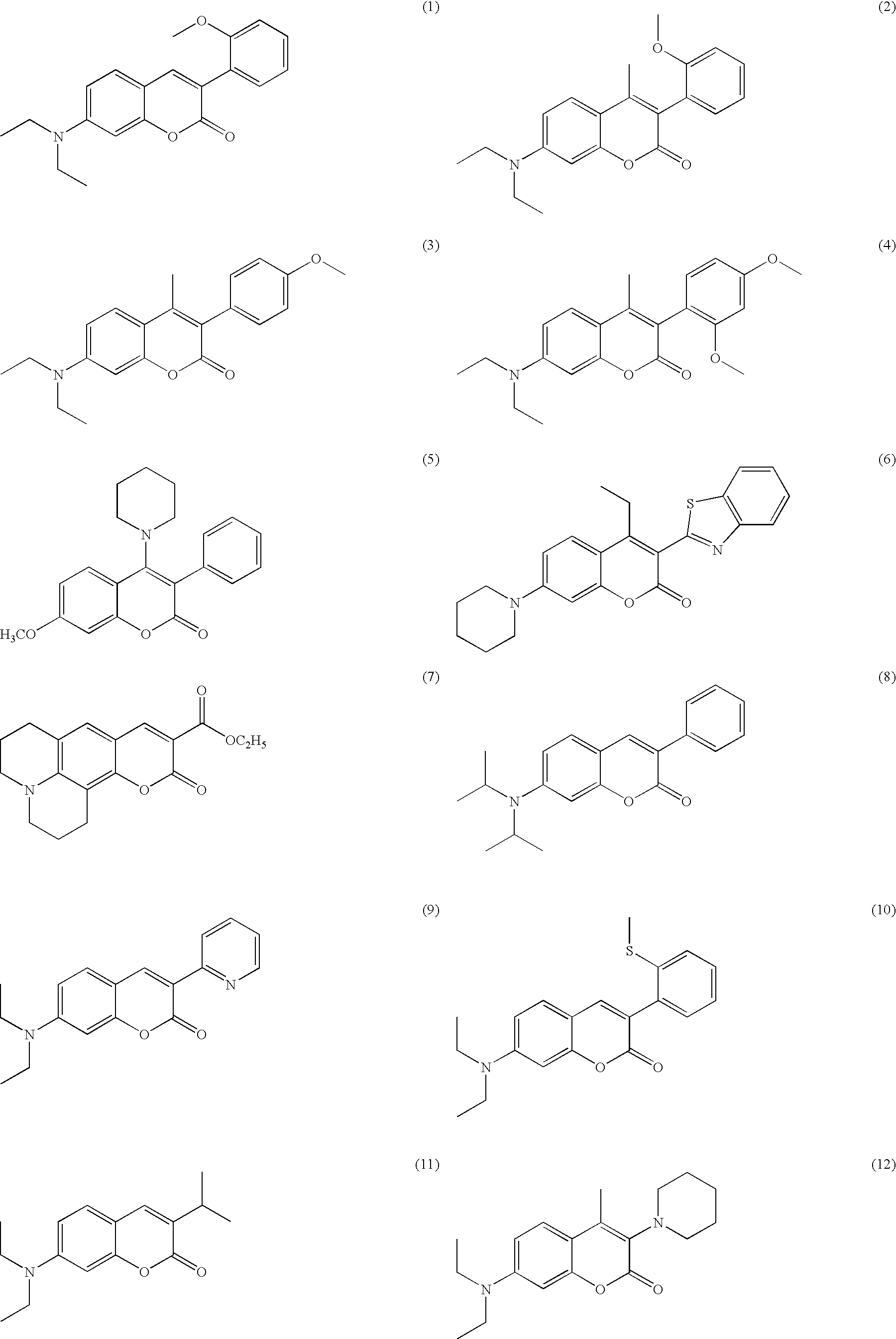

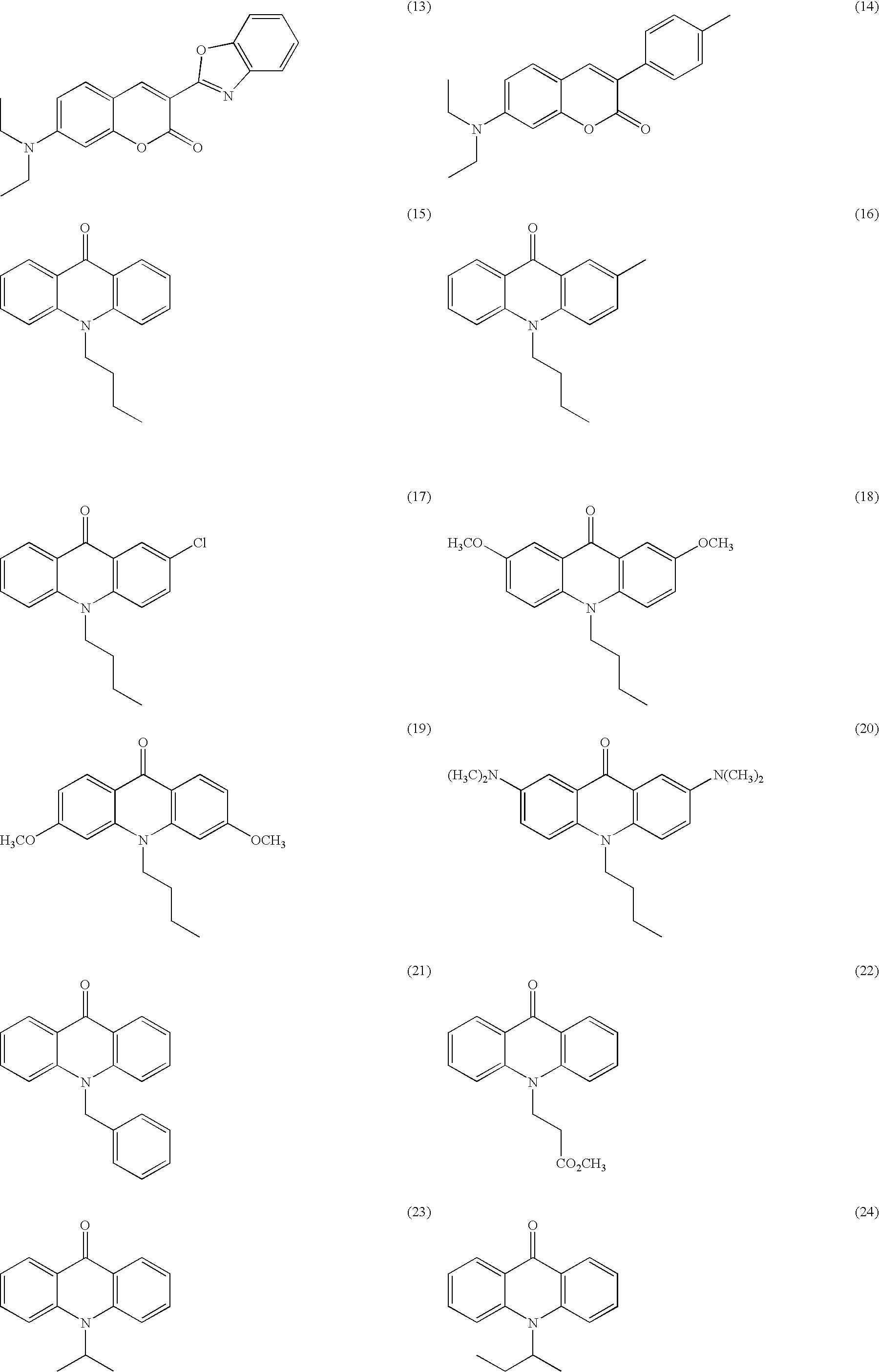

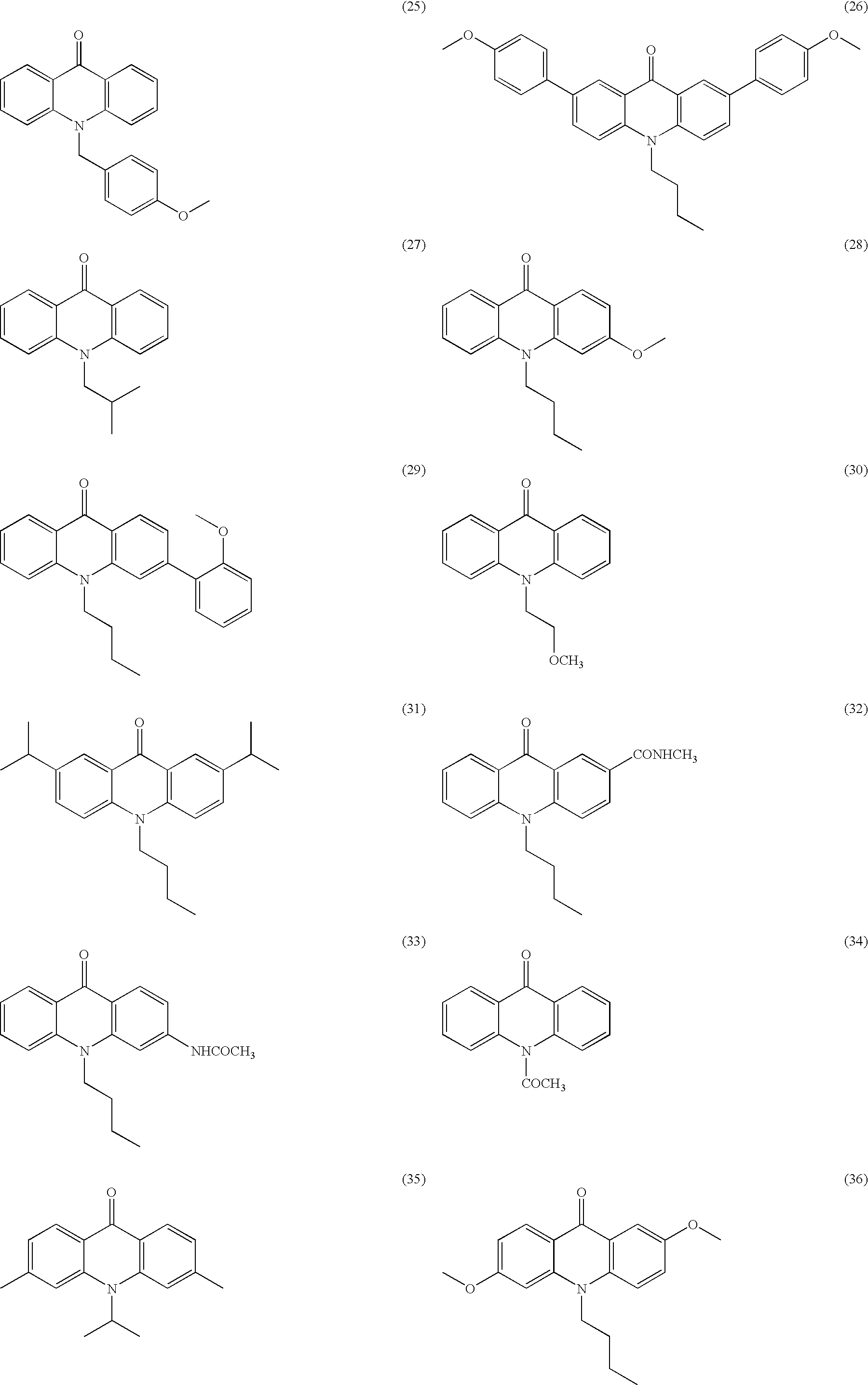

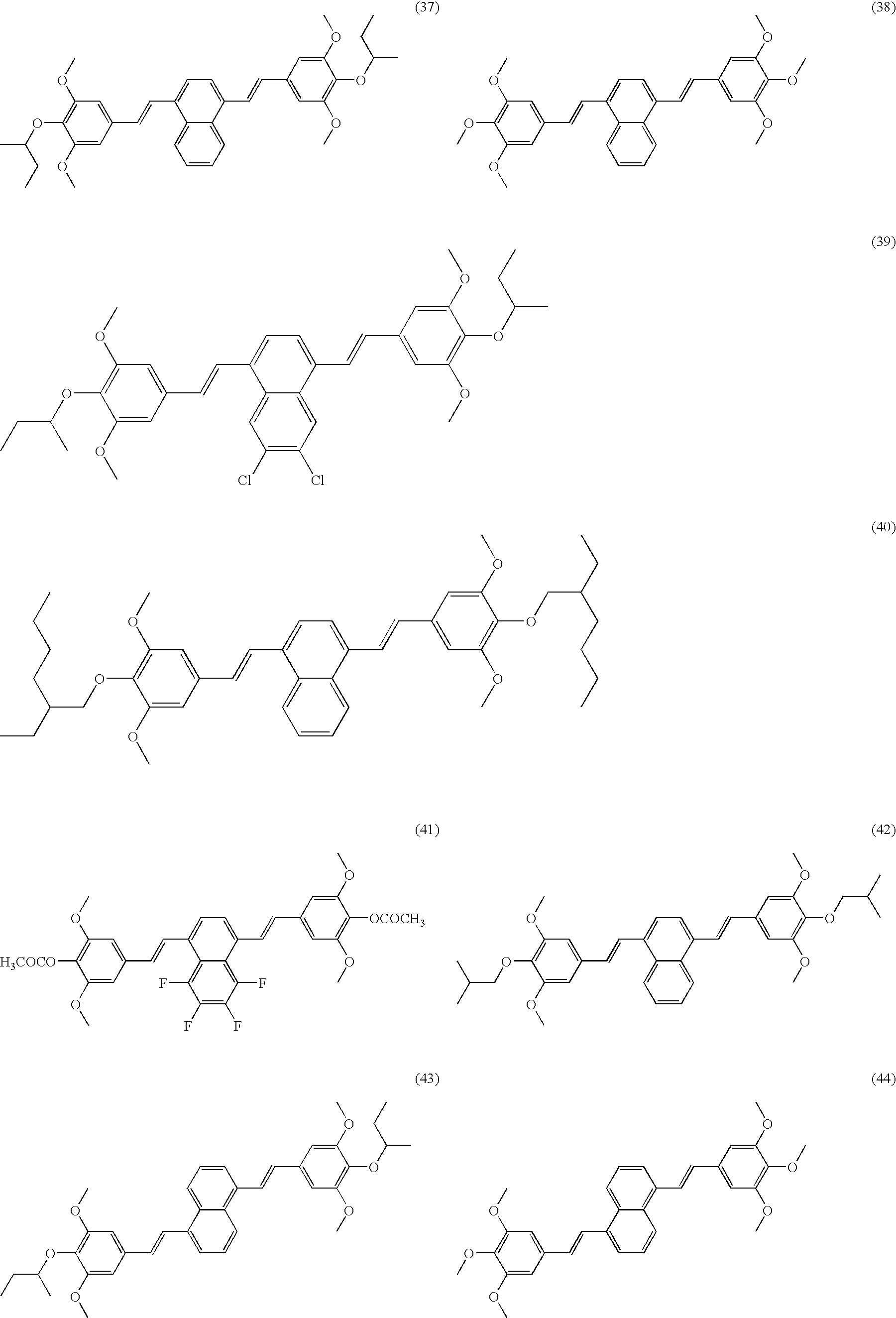

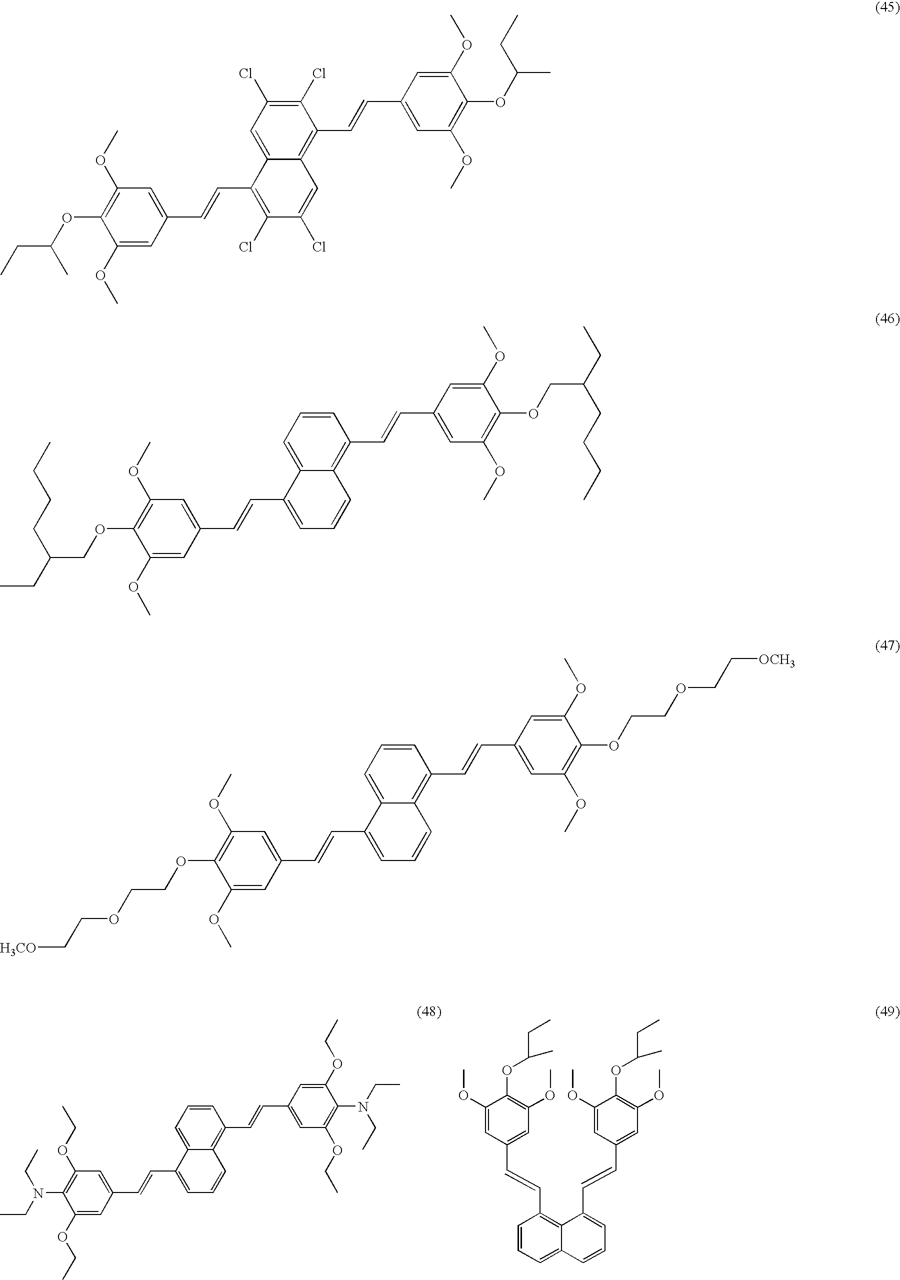

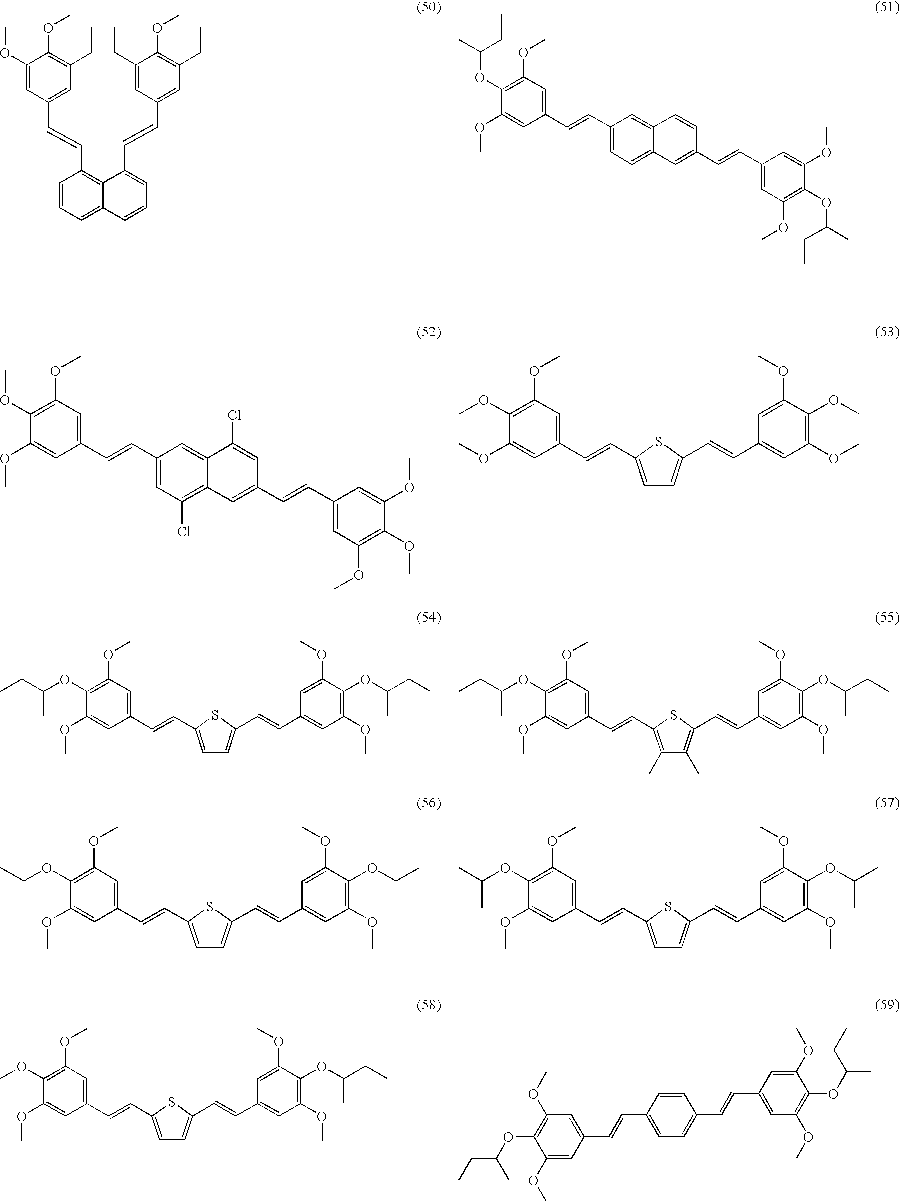

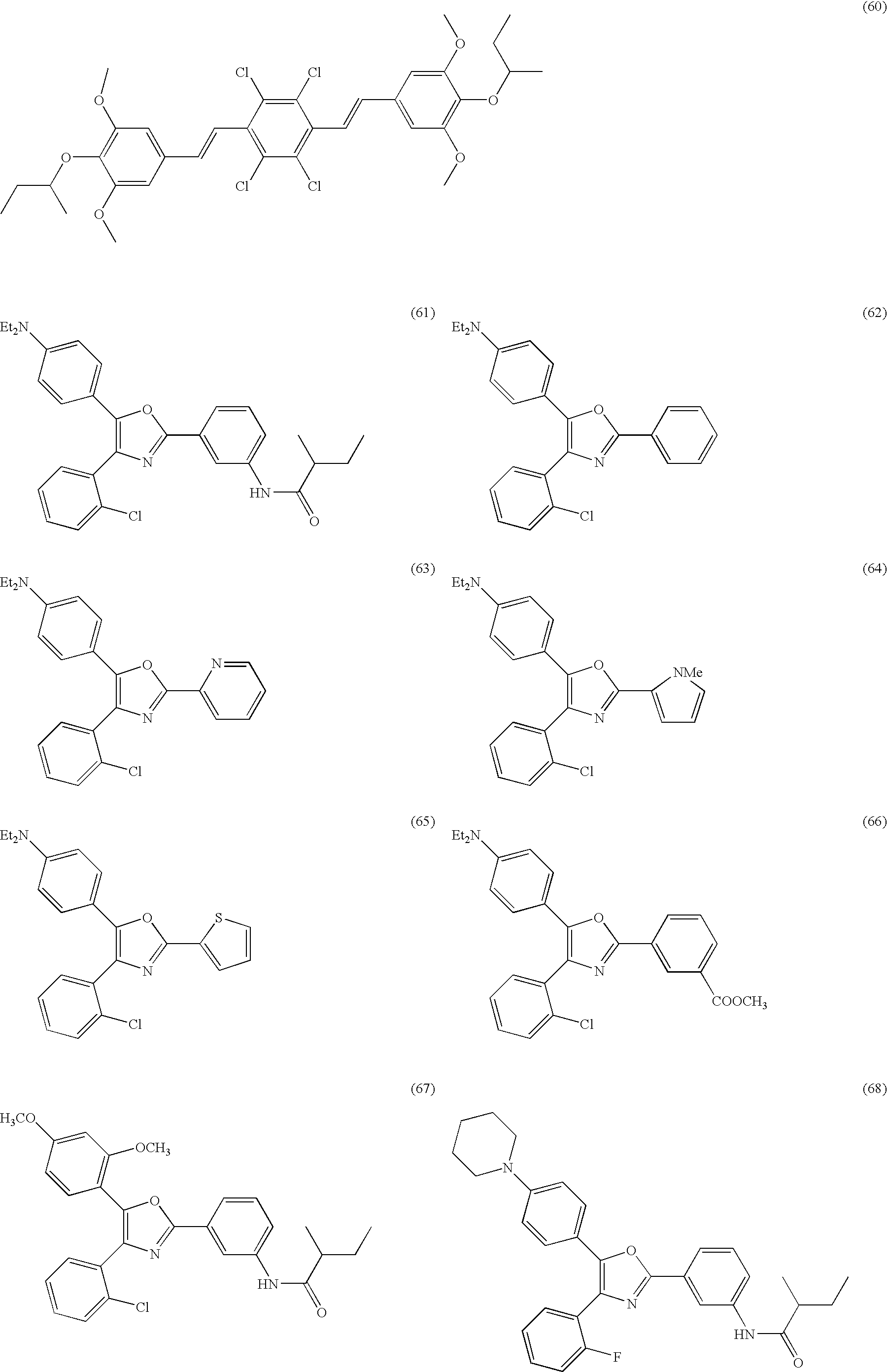

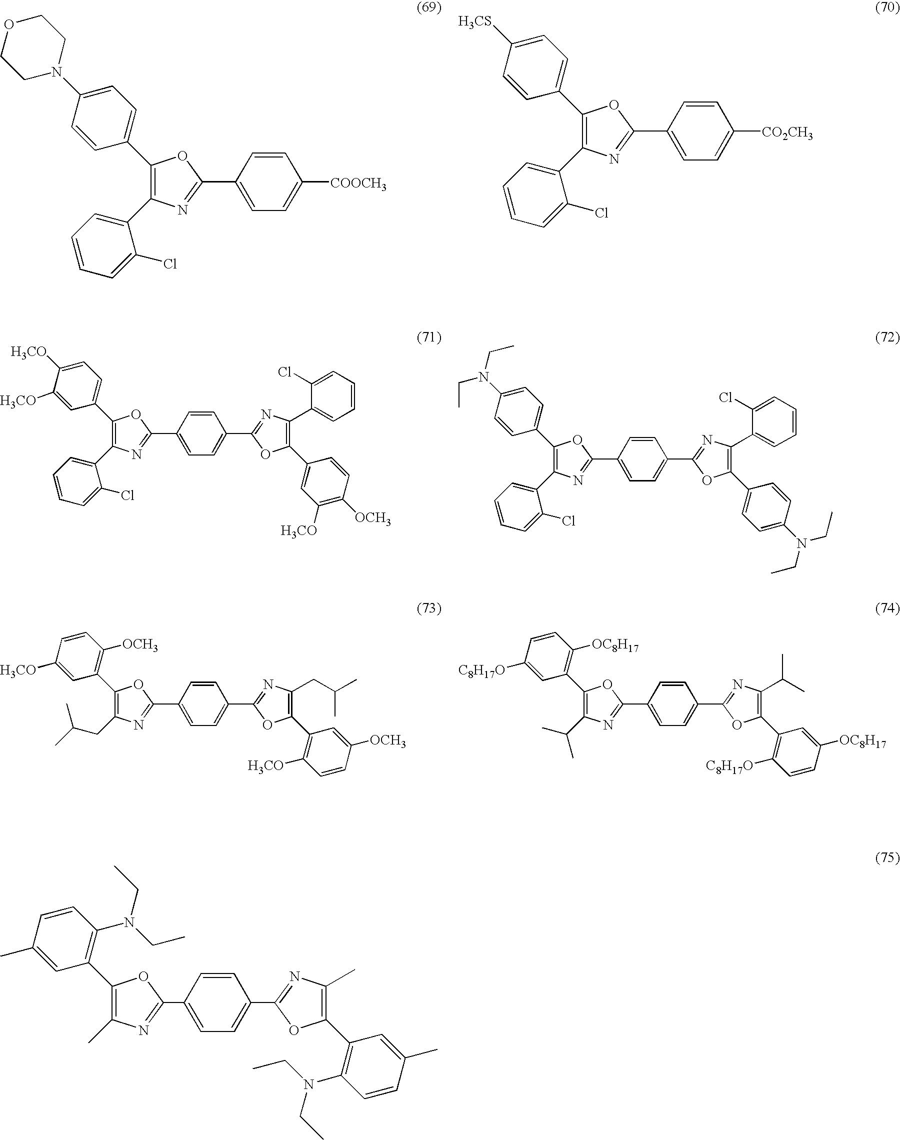

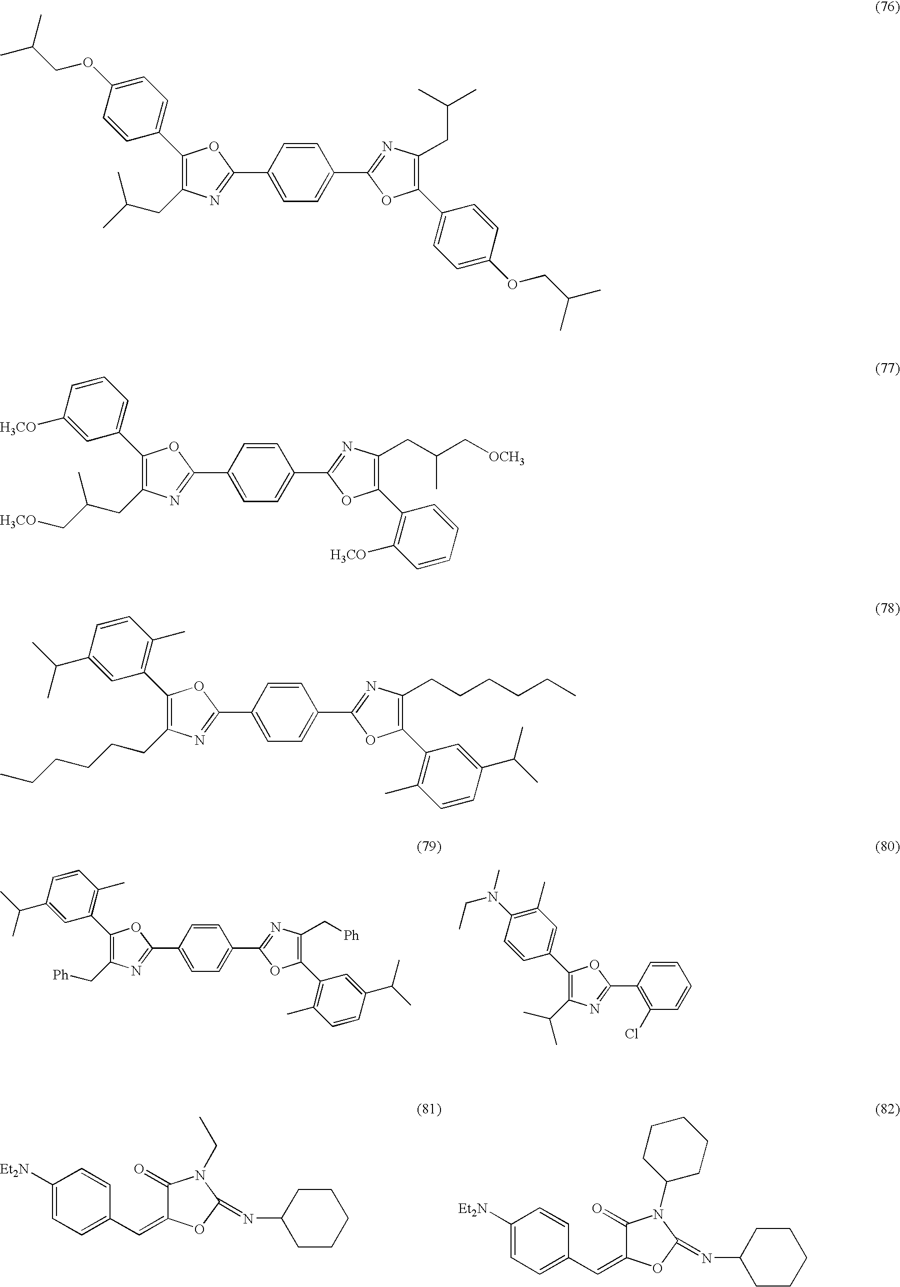

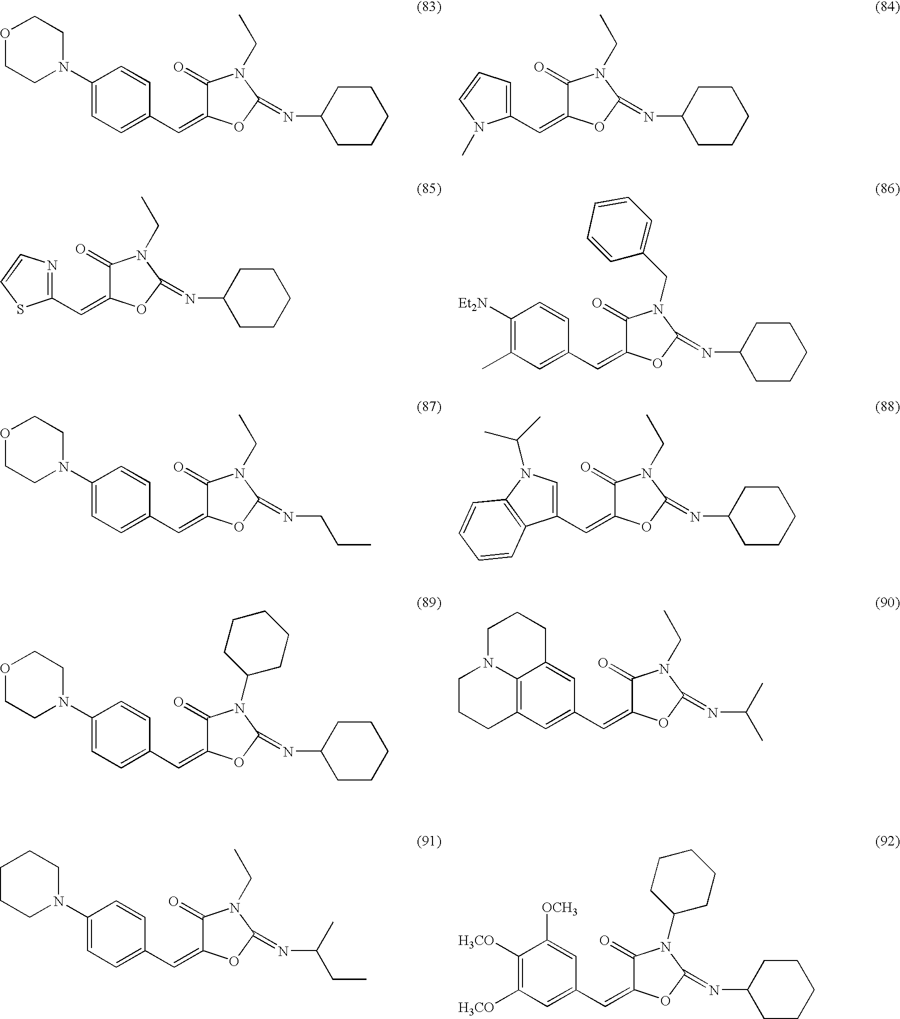

The content of the compound represented by formula 1, 2 or 3 above in the light sensitive layer is preferably from 0.01 to 20% by weight, more preferably from 0.05 to 10% by weight, and still more preferably from 0.1 to 5% by weight, based on the total solid content of light sensitive layer.

In addition to the sensitizing dye described above, the sensitizing dyes, which are disclosed in for example, Japanese Patent O.P.I. Publication Nos. 2000-98605, 2000-147763, 2000-206690, 2000-258910, 2000-309724, 2001-04254, 2002-202598, and 2000-221790, can be used in combination.

The compound represented by formula 1, 2 or 3 can be easily synthesized according to a known synthetic method.

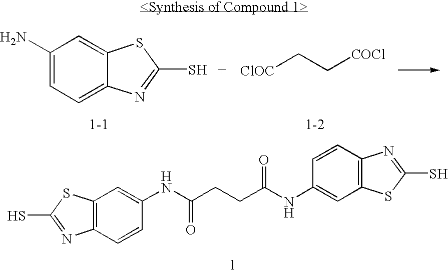

Into 10 ml of acetonitrile were added 1 g of Compound 1-1 and 1.6 ml of pyridine. The resulting suspension was added with o.42 g of Compound 1-2, heated and refluxed for 2 hours while stirring. After that, the reaction mixture was cooled to produce precipitate, and filtered to obtain the precipitate. The precipitate was poured into 30 ml of methanol, heated, washed, filtered off, and dried to obtain 0.84 g of Compound 1 (yield 68%).

Compounds represented by formula 1, 2 or 3 other than Compound 1 can be synthesized in a similar manner as above.

### [Polymerization Initiator]

The polymerization initiator in the invention is a compound which initiates polymerization of an ethylenically unsaturated compound on light exposure. As the polymerization initiator, a titanocene compound, a monoalkyltriaryl borate compound, an iron arene complex, polyhalogenated compound or a biimidazole compound can be used in the invention. Among these, a biimidazole compound is preferred in exhibiting advantageous effects of the invention.

### (Biimidazole Compound)

The biimidazole compound is a derivative of biimidazole, and examples thereof include those disclosed in for example, Japanese Patent O.P.I. Publication No. 2003-295426.

In the invention, a hexaarylbisimidazole (HABI, a dimer of a triarylimidazole) compound is preferred as the biimidazole compound.

The synthetic method of the hexaarylbisimidazoles (HABI, dimmers of triarylimidazoles) is disclosed in DE 1470154, and use thereof in a photopolymerizable composition is disclosed in EP 24629, EP 107792, U.S. Pat. No. 4,410,621, EP 215453 and DE 321312.

Preferred examples of the biimidazole compound include 2,4,5,2′,4′,5′-hexaphenylbisimidazole, 2,2′-bis(2-chlorophenyl)-4,5,4′,5′-tetraphenylbisimidazole, 2,2′-bis(2-bromophenyl)-4 4,5,4′,5′-tetraphenylbisimidazole, 2,2′-bis(2,4-dichlorophenyl)-4,5,4′,5′-tetraphenylbisimidazole, 2,2′-bis(2-chlorophenyl)-4,5,4′,5′-tetrakis(3-methoxyphenyl)bisimidazole, 2,2′-bis(2-chlorophenyl)-4,5,4′,5′-tetrakis(3,4,5-trimethoxyphenyl)bisimidazole, 2,5,2′,5′-tetrakis(2-chlorophenyl)-4,4′-bis(3,4-dimethoxyphenyl)bisimidazole, 2,2′-bis(2,6-dichlorophenyl)-4,5,4′,5′-tetraphenylbisimidazole, 2,2′-bis(2-nitrophenyl)-4,5,4′,5′-tetraphenylbisimidazole, 2,2′-di-o-tolyl-4,5,4′,5′-tetraphenylbisimidazole, 2,2′-bis(2-ethoxyphenyl)-4,5,4′,5′-tetraphenylbisimidazole, and 2,2′-bis(2,6-difluorophenyl)-4,5,4′,5′-tetraphenylbisimidazole.

### (Titanocene Compound)

As the titanocene compounds, there are those described in Japanese Patent O.P.I. Publication Nos. 63-41483 and 2-291. Preferred examples of titanocene compounds include bis(cyclopentadienyl)-Ti-di-chloride, bis(cyclopentadienyl)-Ti-bis-phenyl, bis(cyclopentadienyl)-Ti-bis-2,3,4,5,6-pentaflurophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,6-difluorophenyl (IRUGACURE 784, produced by Ciba Speciality Chemicals Co.), bis(cyclopentadienyl)-bis(2,4,6-trifluoro-3-(pyry-1-yl)phenyl)titanium, and bis(cyclopentadienyl)-bis(2,4,6-trifluoro-3-(2-5-dimethylpyry-1-yl)phenyl)titanium.

### (Monoalkyltriaryl Borate Compound)

As the monoalkyltriaryl borate compounds, there are those described in Japanese Patent O.P.I. Publication Nos. 62-150242 and 62-143044. Preferred examples of the monoalkyltriaryl borate compounds include tetra-n-butyl ammonium n-butyl-trinaphthalene-1-yl-borate, tetra-n-butyl ammonium n-butyl-triphenyl-borate, tetra-n-butyl ammonium n-butyl-tri-(4-tert-butylphenyl)-borate, tetra-n-butyl ammonium n-hexyl-tri-(3-chloro-4-methylphenyl)-borate, and tetra-n-butyl ammonium n-hexyl-tri-(3-fluorophenyl)-borate.

### (Iron-Arene Complex)

As the iron-arene complexes, there are those disclosed in Japanese Patent O.P.I. Publication No. 59-219307.

Preferred examples of the iron-arene complex include η-benzene-(η-cyclopentadienyl)iron hexafluorophosphate, η-cumene-(η-cyclopentadienyl)iron hexafluorophosphate, η-fluorene-(η-cyclopentadienyl)iron hexafluorophosphate, η-naphthalene-η-cyclopentadienyl)iron hexafluorophosphate, η-xylene-η-cyclopentadienyl)iron hexafluorophosphate, and η-benzene-η-cyclopentadienyl)iron tetrafluorophosphate.

### (Polyhalogenated Compound)

As the polyhalogenated compound is preferably used a compound having a trihalomethyl group, a dihalomethyl group or a dihalomethylene group. In the invention, an oxadiazole compound having in the oxadiazole ring the group described above as the substituent or a polyhalogenated compound represented by the following formula 5 or 6 is preferably used. Among these, a polyhalogenated compound represented by the following formula 5 or 6 is more preferably used.

R¹—C(Y)₂—(C═O)—R² Formula 5

wherein R¹ represents a hydrogen atom, a halogen atom, an alkyl group, an aryl group, an acyl group, an alkylsulfonyl group, an arylsulfonyl group, an iminosulfo group or a cyano group; R² represents a monovalent substituent, provided that R¹ and R² may combine with each other to form a ring; and Y represents a halogen atom.

C(Y)₃—(C═O)—X—R³ Formula 6

wherein R³ represents a monovalent substituent; X represents —O— or —NR⁴— in which R⁴ represents a hydrogen atom or an alkyl group, provided that when X represents —NR⁴—, R³ and R⁴ may combine with each other to form a ring; and Y represents a halogen atom.

Among these, a polyhalogenated compound having a polyhaloacetylamido group is preferably used.

An oxadiazole compound having in the oxadiazole ring a polyhalomethyl group as the substituent is preferably used. An oxadiazole compound disclosed in Japanese Patent O.P.I. Publication Nos. 5-34904 and 8-240909 also is preferably used.

### (Another Polymerization Initiator Used in Combination)

Another polymerization initiator can be used in combination. Examples thereof include carbonyl compounds, organic sulfur compounds, peroxides, redox compounds, azo or diazo compounds, halides and photo-reducing dyes disclosed in J. Kosar, “Light Sensitive Systems”, Paragraph 5, and those disclosed in British Patent No. 1,459,563.

Typical examples of the polymerization initiator used in combination include the following compounds:

A benzoin derivative such as benzoin methyl ether, benzoin i-propyl ether, or α,α-dimethoxy-α-phenylacetophenone; a benzophenone derivative such as benzophenone, 2,4-dichlorobenzophenone, o-benzoyl methyl benzoate, or 4,4′-bis (dimethylamino) benzophenone; a thioxanthone derivative such as 2-chlorothioxanthone, 2-i-propylthioxanthone; an anthraquinone derivative such as 2-chloroanthraquinone or 2-methylanthraquinone; an acridone derivative such as N-methylacridone or N-butylacridone; α,α-diethoxyacetophenone; benzil; fluorenone; xanthone; an uranyl compound; a triazine derivative disclosed in Japanese Patent Publication Nos. 59-1281 and 61-9621 and Japanese Patent O.P.I. Publication No. 60-60104; an organic peroxide compound disclosed in Japanese Patent O.P.I. Publication Nos. 59-1504 and 61-243807; a diazonium compound in Japanese Patent Publication Nos. 43-23684, 44-6413, 47-1604 and U.S. Pat. No. 3,567,453; an organic azide compound disclosed in U.S. Pat. Nos. 2,848,328, 2,852,379 and 2,940,853; orthoquinondiazide compounds disclosed in Japanese Patent Publication Nos. 36-22062b, 37-13109, 38-18015 and 45-9610; various onium compounds disclosed in Japanese Patent Publication No. 55-39162, Japanese Patent O.P.I. Publication No. 59-14023 and “Macromolecules”, Volume 10, p. 1307 (1977); azo compounds disclosed in Japanese Patent Publication No. 59-142205; metal arene complexes disclosed in Japanese Patent O.P.I. Publication No. 1-54440, European Patent Nos. 109,851 and 126,712, and “Journal of Imaging Science”, Volume 30, p. 174 (1986); (oxo) sulfonium organoboron complexes disclosed in Japanese Patent O.P.I. Publication Nos. 5-213861 and 5-255347; titanocenes disclosed in Japanese Patent O.P.I. Publication Nos. 59-152396 and 61-151197; transition metal complexes containing a transition metal such as ruthenium disclosed in “Coordination Chemistry Review”, Volume 84, p. 85-277 (1988) and Japanese Patent O.P.I. Publication No. 2-182701; 2,4,5-triarylimidazol dimmer disclosed in Japanese Patent O.P.I. Publication No. 3-209477; carbon tetrabromide; organic halide compounds disclosed in Japanese Patent O.P.I. Publication No. 59-107344.

The content of the polymerization initiator in the light sensitive layer is preferably from 0.1 to 20% by weight, and more preferably from 0.5 to 15% by weight, based on the weight of polymerizable ethylenically unsaturated compound described later.

### [Polymerizable Ethylenically Unsaturated Compound]

Next, the polymerizable ethylenically unsaturated compound (hereinafter also referred to as ethylenically unsaturated compound) will be explained.

In the invention, the polymerizable ethylenically unsaturated compound is preferably a reaction product of the following compounds C1, C2 and C3.
(Compound C1): a compound having both at least one ethylenically double bond and one hydroxyl group in the molecule
(Compound C2): a diisocyanate compound
(Compound C3): a compound selected from a diol having a tertiary amino structure in the molecule and a compound having one secondary amino group and one hydroxyl group in the molecule.

Examples of compound C1 include 2-hydroxyethyl methacrylate, 4-hydroxybutyl acrylate, and 2-hydroxypropyl methacrylate. Examples of compound C2 include 1,3-bis(1-cyanato-1-methylethyl)benzene, 1,3-dicyanatobenzene, 1,3-dicyanato-4-methylbenzene, and 1,3-di(cyanatomethyl)benzene. Examples of compound C3 include N-n-butyldiethanolamine, N-methyldiethanolamine, 1,4-di(2-hydroxyethyl)piperazine, and N-ethyldiethanolamine.

### (Compound Represented by Formula 4)

As the reaction product as described above, a compound represented by formula 4 above is preferably used.

In formula 4 above, R¹ represents a hydrogen atom or a methyl group; X¹ represents a divalent aliphatic hydrocarbon group; X² represents a divalent hydrocarbon group containing an aromatic ring in it; and X³ represents a divalent linkage group having a tertiary amino group.

Examples of the divalent aliphatic hydrocarbon group represented by X¹ include —CH₂CH₂—, —CH₂CH(CH₃)—, —CH(CH₃)CH₂—, —CH₂CH₂CH₂—, and —CH₂CH₂CH₂CH₂. Among these, —CH₂CH₂—, —CH₂CH(CH₃)— and —CH(CH₃)CH₂— are preferred.

Examples of X² include a divalent hydrocarbon group represented by one of the following formulae X2-1 through X2-10.

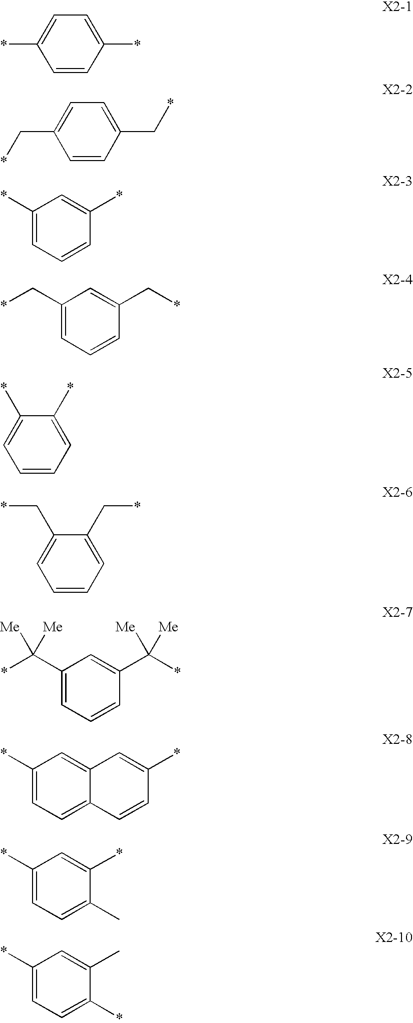

In the formulae X2-1 through X2-10 above, asterisk “*” represents a linkage site at which the divalent hydrocarbon group combines with —NH—.

Among these, X2-3, X2-4, X2-7, X2-9, and X2-10 are preferred.

Example of X³ include a divalent linkage group represented by one of the following formulae X3-1 through X3-10:

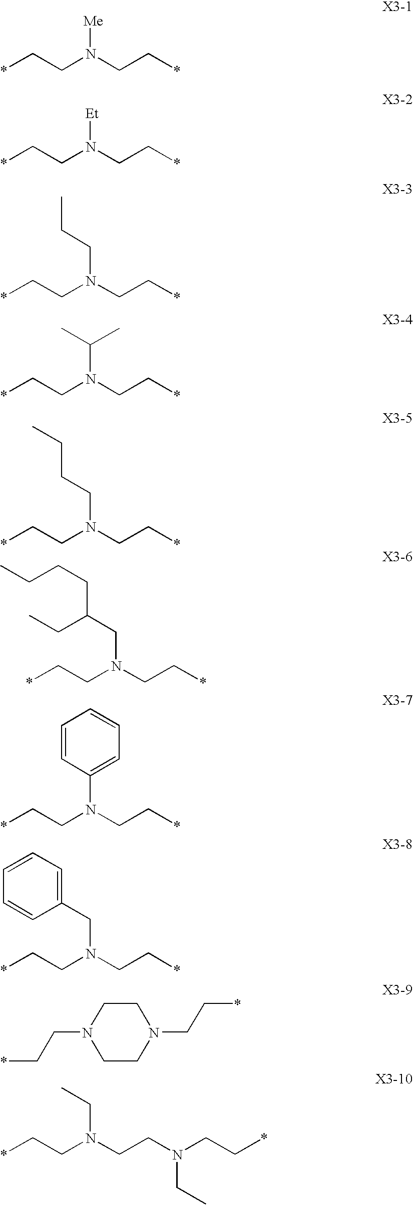

In formulae X3-1 through X3-10 above, asterisk “*” represents a linkage site at which the divalent hydrocarbon group combines with —O—.

Examples of the compound represented by formula 4 will be listed below.

| | R¹ | X¹ | X² | X³ |
|---|---|---|---|---|
| M1-1 | —CH₃ | —CH₂CH₂— | 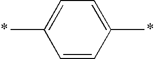 | 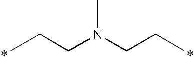 |
| M1-2 | —CH₃ | —CH₂CH₂— | 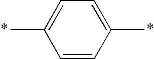 | 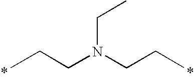 |
| M1-3 | —CH₃ | —CH₂CH₂— | 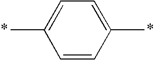 | 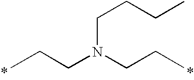 |
| M1-4 | —CH₃ | —CH₂CH₂— | 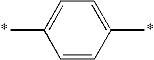 | 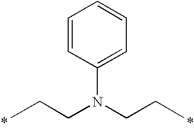 |
| M1-5 | —CH₃ | —CH₂CH₂— | 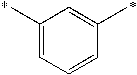 | 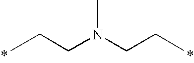 |
| M1-6 | —CH₃ | —CH₂CH₂— | 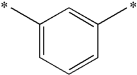 | 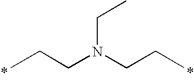 |
| M1-7 | —CH₃ | —CH₂CH₂— | 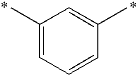 | 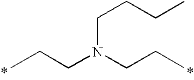 |
| M1-8 | —CH₃ | —CH₂CH₂— | 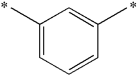 | 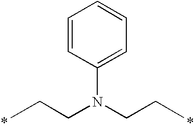 |
| M1-9 | —CH₃ | —CH₂CH₂— | 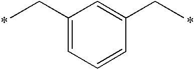 | 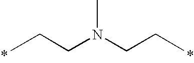 |
| M1-10 | —CH₃ | —CH₂CH₂— | 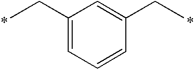 | 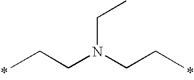 |
| M1-11 | —CH₃ | —CH₂CH₂— | 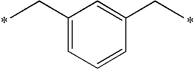 | 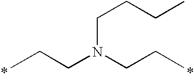 |
| M1-12 | —CH₃ | —CH₂CH₂— | 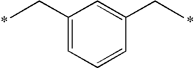 | 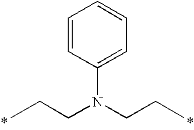 |
| M1-13 | —CH₃ | —CH₂CH₂— | 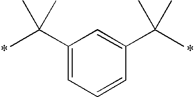 | 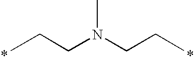 |
| M1-14 | —CH₃ | —CH₂CH₂— | 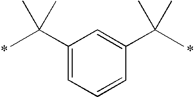 | 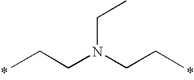 |
| M1-15 | —CH₃ | —CH₂CH₂— | 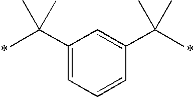 | 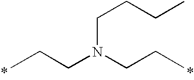 |
| M1-16 | —CH₃ | —CH₂CH₂— | 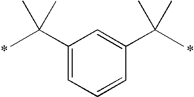 | 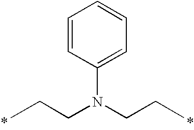 |
| M2-1 | —H | —CH₂CH₂— | 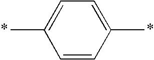 | 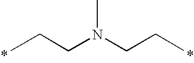 |
| M2-2 | —H | —CH₂CH₂— | 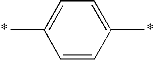 | 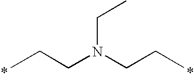 |
| M2-3 | —H | —CH₂CH₂— | 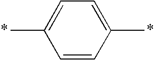 | 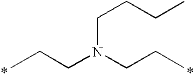 |
| M2-4 | —H | —CH₂CH₂— | 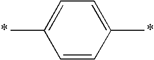 | 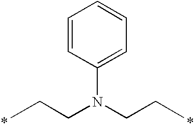 |
| M2-5 | —H | —CH₂CH₂— | 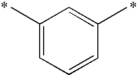 | 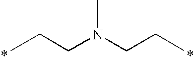 |
| M2-6 | —H | —CH₂CH₂— | 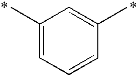 | 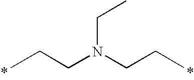 |
| M2-7 | —H | —CH₂CH₂— | 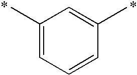 | 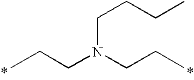 |
| M2-8 | —H | —CH₂CH₂— | 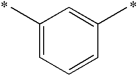 | 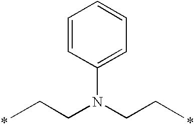 |
| M2-9 | —H | —CH₂CH₂— | 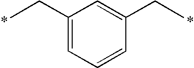 | 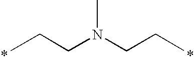 |
| M2-10 | —H | —CH₂CH₂— | 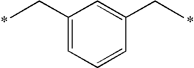 | 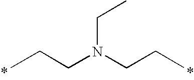 |
| M2-11 | —H | —CH₂CH₂— | 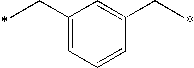 | 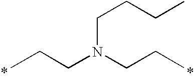 |
| M2-12 | —H | —CH₂CH₂— | 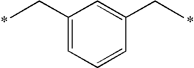 | 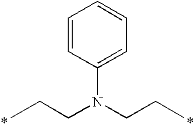 |
| M2-13 | —H | —CH₂CH₂— | 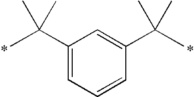 | 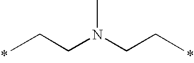 |
| M2-14 | —H | —CH₂CH₂— | 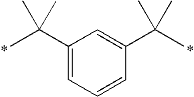 | 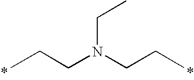 |
| M2-15 | —H | —CH₂CH₂— | 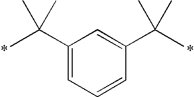 | 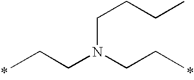 |
| M2-16 | —H | —CH₂CH₂— | 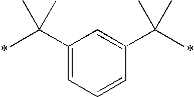 | 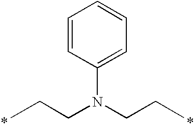 |
| M3-1 | —CH₃ | —CH₂—CH(CH₃)— | 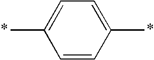 | 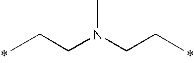 |
| M3-2 | —CH₃ | —CH₂—CH(CH₃)— | 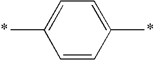 | 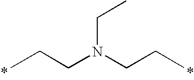 |
| M3-3 | —CH₃ | —CH₂—CH(CH₃)— | 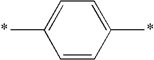 | 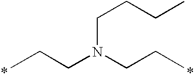 |
| M3-4 | —CH₃ | —CH₂—CH(CH₃)— | 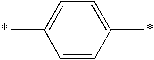 | 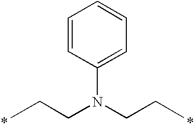 |
| M3-5 | —CH₃ | —CH₂—CH(CH₃)— | 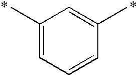 | 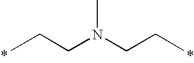 |
| M3-6 | —CH₃ | —CH₂—CH(CH₃)— | 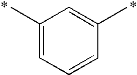 | 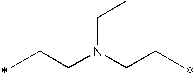 |
| M3-7 | —CH₃ | —CH₂—CH(CH₃)— | 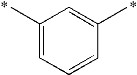 | 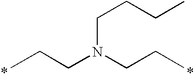 |
| M3-8 | —CH₃ | —CH₂—CH(CH₃)— | 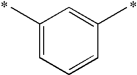 | 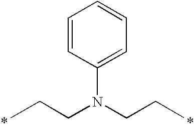 |
| M3-9 | —CH₃ | —CH₂—CH(CH₃)— | 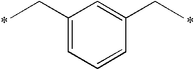 | 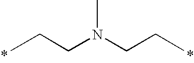 |
| M3-10 | —CH₃ | —CH₂—CH(CH₃)— | 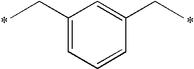 | 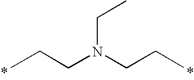 |
| M3-11 | —CH₃ | —CH₂—CH(CH₃)— | 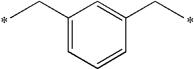 | 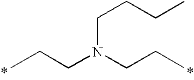 |
| M3-12 | —CH₃ | —CH₂—CH(CH₃)— | 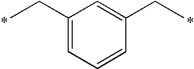 | 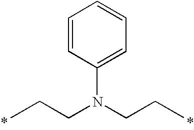 |
| M3-13 | —CH₃ | —CH₂—CH(CH₃)— | 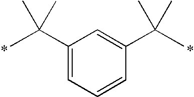 | 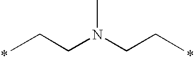 |
| M3-14 | —CH₃ | —CH₂—CH(CH₃)— | 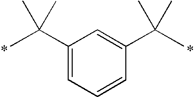 | 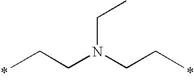 |
| M3-15 | —CH₃ | —CH₂—CH(CH₃)— | 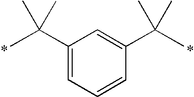 | 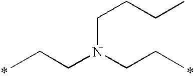 |
| M3-16 | —CH₃ | —CH₂—CH(CH₃)— | 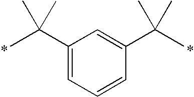 | 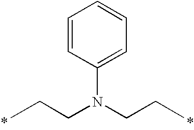 |
| M4-1 | —H | —(CH₂)₄— | 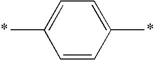 | 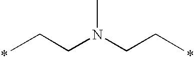 |
| M4-2 | —H | —(CH₂)₄— | 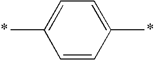 | 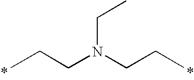 |
| M4-3 | —H | —(CH₂)₄— | 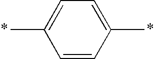 | 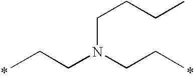 |
| M4-4 | —H | —(CH₂)₄— | 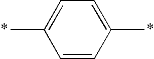 | 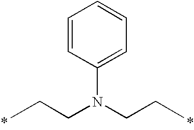 |
| M4-5 | —H | —(CH₂)₄— | 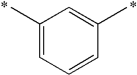 | 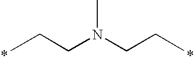 |
| M4-6 | —H | —(CH₂)₄— | 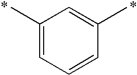 | 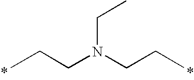 |
| M4-7 | —H | —(CH₂)₄— | 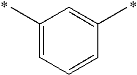 | 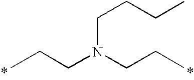 |
| M4-8 | —H | —(CH₂)₄— | 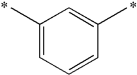 | 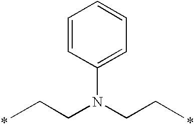 |
| M4-9 | —H | —(CH₂)₄— | 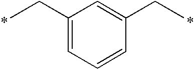 | 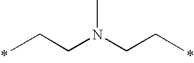 |
| M4-10 | —H | —(CH₂)₄— | 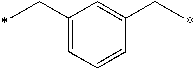 | 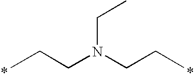 |
| M4-11 | —H | —(CH₂)₄— | 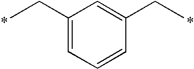 | 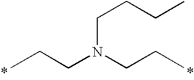 |
| M4-12 | —H | —(CH₂)₄— | 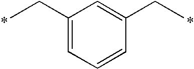 | 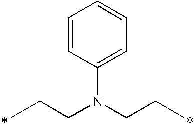 |
| M4-13 | —H | —(CH₂)₄— | 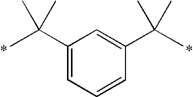 | 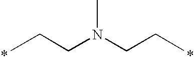 |
| M4-14 | —H | —(CH₂)₄— | 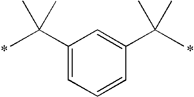 | 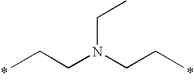 |
| M4-15 | —H | —(CH₂)₄— | 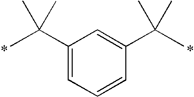 | 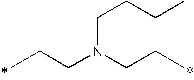 |
| M4-16 | —H | —(CH₂)₄— | 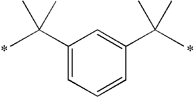 | 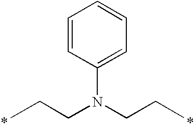 |

In the above compounds M1-1 through M4-16, asterisk * of X² or X³ represents a linkage site at which X² and X³ combine with —NH— and —O—, respectively.

### (Another Ethylenically Unsaturated Compound)

As another ehtylenically unsaturated compound used in the invention, there are a known monomer such as a conventional radically polymerizable monomer and a polyfunctional monomer or oligomer having two or more of an ethylenic double bond in the molecule generally used in a conventional ultraviolet curable resin composition.

These monomers are not specifically limited. Typical examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryl-oxyethyl acrylate, tetrahydrofurfuryloxyhexanorideacrylate, an ester of 1,3-dioxane-ε-caprolactone adduct with acrylic acid, or 1,3-dioxolane acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate or hydroxpivalylaldehyde modified dimethylolpropane triacrylate; a methacrylate, itaconate, crotonate or maleate alternative of the above polyfunctional acrylate.

A prepolymer can be used, and examples of the prepolymer include compounds as described later. The prepolymer with a photopolymerizable property, which is obtained by incorporating acrylic acid or methacrylic in an oligomer with an appropriate molecular weight, can be suitably employed. These prepolymers can be used singly, in combination or as their mixture with the above described monomers and/or oligomers.

Examples of the prepolymer include polyester (meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, grycerin, trimethylol propane, pentaerythritol, sorbitol, 1,6-hexanediol or 1,2,6-hexanetriol; an epoxyacrylate such as bisphenol A•epichlorhydrin•(meth)acrylic acid or phenol novolak•epichlorhydrin•(meth)acrylic acid obtained by incorporating (meth)acrylic acid in an epoxy resin; an urethaneacrylate such as ethylene glycol•adipic acid•tolylenediisocyanate•2-hydroxyethylacrylate, polyethylene glycol•tolylenediisocyanate•2-hydroxyethylacrylate, hydroxyethylphthalyl methacrylate•xylenediisocyanate, 1,2-polybutadieneglycol•tolylenediisocyanate-2-hydroxyethylacrylate or trimethylolpropane•propylene glycol•tolylenediisocyanate•2-hydroxyethylacrylate, obtained by incorporating (meth)acrylic acid in an urethane resin; a silicone acrylate such as polysiloxane acrylate, or polysiloxane•diisocyanate•2-hydroxyethylacrylate; an alkyd modified acrylate obtained by incorporating a methacroyl group in an oil modified alkyd resin; and a spiran resin acrylate.

The light sensitive layer in the invention may contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer.

The ethylenic monomer used in the invention is preferably a phosphate compound having at least one (meth)acryloyl group. The phosphate compound is a compound having a (meth)acryloyl group in which at least one hydroxyl group of phosphoric acid is esterified, and the phosphate compound is not limited as long as it has a (meth)acryloyl group.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV•EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

In addition to the above, acrylates or methacrylates disclosed in Japanese Patent O.P.I. Publication Nos. 2-105238 and 1-127404 can be used.

The ethylenically unsaturated compound content of the light sensitive layer is preferably from 20 to 80 by weight, and more preferably from 30 to 70% by weight based on the weight of light sensitive layer.

### [Polymeric Binder]

As the polymeric binder in the invention can be used a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These resins can be used as an admixture of two or more thereof.

The polymeric binder used in the invention is preferably a vinyl copolymer obtained by copolymerization of an acryl monomer, and more preferably a copolymer containing (a) a carboxyl group-containing monomer unit and (b) an alkyl methacrylate or alkyl acrylate unit as the copolymerization component.

Examples of the carboxyl group-containing monomer include an α,β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The polymeric binder in the invention can further contain, as another monomer unit, a monomer unit derived from the monomer described in the following items (1) through (14):

(1) A monomer having an aromatic hydroxy group, for example, o-, (p- or m-) hydroxystyrene, or o-, (p- or m-) hydroxyphenylacrylate;

(2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;

(3) A monomer having an aminosulfonyl group, for example, m- or p-aminosulfonylphenyl methacrylate, m- or p-aminosulfonylphenyl acrylate, N-(p-aminosulfonylphenyl)methacrylamide, or N-(p-aminosulfonylphenyl)acrylamide;

(4) A monomer having a sulfonamido group, for example, N-(p-toluenesulfonyl)acrylamide, or N-(p-toluenesulfonyl)-methacrylamide;

(5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;

(6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;

(7) A vinyl ether, for example, ethyl vinyl ether, 2-chloroethyl vinyl ether, propyl vinyl ether, butyl vinyl ether, octyl vinyl ether, or phenyl vinyl ether;

(8) A vinyl ester, for example, vinyl acetate, vinyl chroloacetate, vinyl butyrate, or vinyl benzoate;

(9) A styrene, for example, styrene, methylstyrene, or chloromethystyrene;

(10) A vinyl ketone, for example, methyl vinyl ketone, ethyl vinyl ketone, propyl vinyl ketone, or phenyl vinyl ketone;

(11) An olefin, for example, ethylene, propylene, isobutylene, butadiene, or isoprene;

(12) N-vinylpyrrolidone, N-vinylcarbazole, or N-vinylpyridine, (13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;

(14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer. The polymeric binder is preferred which has, in the side chain of the molecule, both carboxyl group and polymerizable double bond. For example, an unsaturated bond-containing copolymer is preferred which is obtained by reacting a carboxyl group contained in the above vinyl copolymer molecule with for example, a compound having a (meth)acryloyl group and an epoxy group.

Examples of the compound having a double bond and an epoxy group in the molecule include glycidyl acrylate, glycidyl methacrylate and an epoxy group-containing unsaturated compound disclosed in Japanese Patent O.P.I. Publication No. 11-27196. Further, an unsaturated bond-containing copolymer which is obtained by reacting a hydroxyl group contained in the above vinyl copolymer molecule with for example, a compound having a (meth)acryloyl group and an isocyanate group. Examples of the compound having a (meth)acryloyl group and an isocyanate group in the molecule include vinyl isocyanate, (meth)acryl isocyanate, 2-(meth)acroyloxyethyl isocyanate, m- or p-isopropenyl-α,α′-dimethylbenzyl isocyanate, and (meth)acryl isocyanate, or 2-(meth)acroyloxyethyl isocyanate is preferred.

The content of the polymeric binder having in the side chain of the molecule both carboxyl group and polymerizable double bond in the light sensitive layer is preferably from 50 to 100% by weight, and more preferably 100W by weight, based on the total content of the polymeric binder contained in the light sensitive layer.

The content of the polymeric binder in the light sensitive layer is preferably from 10 to 90W by weight, more preferably from 15 to 70 by weight, and still more preferably from 20 to 50 by weight, in view of sensitivity.

### [Various Additives]

The light sensitive layer in the invention is preferably added with a polymerization inhibitor, in order to prevent undesired polymerization of the ethylenically unsaturated compound during the manufacture or after storage of light sensitive planographic printing plate material.

### (Polymerization Inhibitor)

Examples of the polymerization inhibitor include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and 2-t-butyl-6-(3-t-butyl-6-hydroxy-5-mrthylbenzyl)-4-methylphenyl acrylate.

The polymerization inhibitor content is preferably 0.01 to 5% by weight based on the total solid content of the light sensitive layer. Further, in order to prevent undesired polymerization induced by oxygen, behenic acid or a higher fatty acid derivative such as behenic amide may be added to the layer. After the light sensitive layer is coated layer, the coated layer may be dried so that the higher fatty acid derivative is localized at the vicinity of the surface of the light sensitive layer. The content of the higher fatty acid derivative is preferably 0.5 to 10% by weight, based on the total solid content of the light sensitive layer.

(Colorant) A colorant can be also used. As the colorant can be used known materials including commercially available materials. Examples of the colorant include those described in revised edition “Ganryo Binran”, edited by Nippon Ganryo Gijutu Kyoukai (publishe by Seibunndou Sinkosha), or “Color Index Binran”. Pigment is preferred.

Kinds of the pigment include black pigment, yellow pigment, red pigment, brown pigment, violet pigment, blue pigment, green pigment, fluorescent pigment, and metal powder pigment. Examples of the pigment include inorganic pigment (such as titanium dioxide, carbon black, graphite, zinc oxide, Prussian blue, cadmium sulfide, iron oxide, or chromate of lead, zinc, barium or calcium); and organic pigment (such as azo pigment, thioindigo pigment, anthraquinone pigment, anthanthrone pigment, triphenedioxazine pigment, vat dye pigment, phthalocyanine pigment or its derivative, or quinacridone pigment).

Among these pigment, pigment is preferably used which does not substantially have absorption in the absorption wavelength regions of a spectral sensitizing dye used according to a laser for exposure. The absorption of the pigment used is not more than 0.05, obtained from the reflection spectrum of the pigment measured employing an integrating sphere and employing light with the wavelength of the laser used. The pigment content is preferably 0.1 to 10% by weight, and more preferably 0.2 to 5% by weight, based on the total solid content of the photopolymerizable light sensitive layer composition.

A purple pigment or a blue pigment is preferably utilized in view of absorption of light with the aforesaid photosensitive wavelength region and image visibility after development. Such pigments include, for example, Cobalt Blue, cerulean blue, Alkali Blue, Phonatone Blue 6G, Victoria Blue Lake, metal-free Phthalocyanine Blue, Phthalocyanine Fast Sky Blue, Indathrene Blue, indigo, Dioxane Violet, Isoviolanthrone Violet, Indanthrone Blue and Indanthrone BC. Among them, more preferable are Phthalocyanine Blue and Dioxane Violet.

### (Surfactant)

The light sensitive layer can contain surfactants as a coating improving agent as long as the performance of the invention is not jeopardized. Among these surfactants, a fluorine-contained surfactant is preferred.

Further, in order to improve physical properties of the cured light sensitive layer, the layer can contain an inorganic filler or a plasticizer such as dioctyl phthalate, dimethyl phthalate or tricresyl phosphate. The content of such a material is preferably not more than 10% by weight, based on the total solid content of the light sensitive layer.

The solvents used in the preparation of the coating liquid for the light sensitive layer in the invention include an alcohol such as sec-butanol, isobutanol, n-hexanol, or benzyl alcohol; a polyhydric alcohol such as diethylene glycol, triethylene glycol, tetraethylene glycol, or 1,5-pentanediol; an ether such as propylene glycol monobutyl ether, dipropylene glycol monomethyl ether, or tripropylene glycol monomethyl ether; a ketone or aldehyde such as diacetone alcohol, cyclohexanone, or methyl cyclohexanone; and an ester such as ethyl lactate, butyl lactate, diethyl oxalate, or methyl benzoate.

In the above, explanation of a light sensitive layer coating liquid was made. The light sensitive layer in the invention is formed on a support by coating on the support the light sensitive layer coating liquid.

The coating amount of the light sensitive layer is preferably from 0.1 to 10 g/m², and more preferably from 0.5 to 5 g/m².

### [Protective Layer (Oxygen Shielding Layer)]

In the invention, a protective layer is preferably provided on the light sensitive layer.

It is preferred that the protective layer (oxygen shielding layer) is highly soluble in the developer as described later (generally an alkaline solution). Polyvinyl alcohol or polyvinyl pyrrolidone is preferably used in the protective layer. Polyvinyl alcohol has the effect of preventing oxygen from transmitting and polyvinyl pyrrolidone has the effect of increasing adhesion between the oxygen shielding layer and the light sensitive layer.

Besides the above two polymers, the oxygen shielding layer may contain a water soluble polymer such as polysaccharide, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide.

In the planographic printing plate material in the invention, adhesive strength between the protective layer and the light sensitive layer is preferably not less than 35 mN/mm, more preferably not less than 50 mN/mm, and still more preferably not less than 75 mN/mm. Preferred composition of the protective layer is disclosed in Japanese Patent Application No. 8-161645.

The adhesive strength can be determined according to the following method. The adhesive tape with a sufficient adhesive force is applied on the protective layer, and then peeled together with the protective layer under the applied tape in the normal direction relative to the protective layer surface. Force necessary to peel the tape together with the protective layer is defined as adhesive strength.

The protective layer may further contain a surfactant or a matting agent. The protective layer is formed, coating on the photopolymerizable light sensitive layer a coating solution in which the above protective layer composition is dissolved in an appropriate coating solvent, and drying. The main solvent of the coating solution is preferably water or an alcohol solvent such as methanol, ethanol, or iso-propanol.

The coating amount of the protective layer is preferably 0.1 to 5.0 g/m², and more preferably 0.5 to 3.0 g/m².

### [Support]

The support used in the invention is a plate or a sheet capable of carrying the light sensitive layer and preferably has a hydrophilic surface on the side on which the light sensitive layer is to be provided.

As the supports used in the invention, a plate of a metal such as aluminum, stainless steel, chromium or nickel, or a plastic film such as a polyester film, a polyethylene film or a polypropylene film, which is deposited or laminated with the above-described metal can be used. Further, a polyester film, a polyvinyl chloride film or a nylon film whose surface is subjected to hydrophilization treatment can be used. Among the above, the aluminum plate is preferably used, and may be a pure aluminum plate or an aluminum alloy plate.

As the aluminum alloy, there can be used various ones including an alloy of aluminum and a metal such as silicon, copper, manganese, magnesium, chromium, zinc, lead, bismuth, nickel, titanium, sodium or iron. In the aluminum plate for the support, the surface is roughened for water retention.

It is preferable that the aluminum plate is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting support is preferably subjected to desmut treatment in an aqueous solution of an acid such as phosphoric acid, nitric acid, sulfuric acid, chromic acid, or a mixture thereof, since smut is produced on the surface of the support. The surface roughening methods include a mechanical surface roughening method and an electrolytic surface roughening method electrolytically etching the support surface.

Though there is no restriction for the mechanical surface roughening method, a brushing roughening method and a honing roughening method are preferable.

Though there is no restriction for the electrolytic surface roughening method, a method, in which the support is electrolytically surface roughened in an acidic electrolytic solution, is preferred.

After the support has been electrolytically surface roughened, it is preferably dipped in an acid or an aqueous alkali solution in order to remove aluminum dust, etc. produced in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used.

The dissolution amount of aluminum in the support surface is preferably 0.5 to 5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

The mechanical surface roughening and electrolytic surface roughening may be carried out singly, and the mechanical surface roughening followed by the electrolytic surface roughening may be carried out.

After the surface roughening, anodizing treatment may be carried out. There is no restriction in particular for the method of anodizing treatment used in the invention, and known methods can be used. The anodizing treatment forms an anodization film on the surface of the support.

The support which has been subjected to anodizing treatment is optionally subjected to sealing treatment. For the sealing treatment, it is possible to use known methods using hot water, boiling water, steam, a sodium silicate solution, an aqueous dichromate solution, a nitrite solution and an ammonium acetate solution.

After the above treatment, the support is suitably undercoated with a water soluble resin such as polyvinyl phosphonic acid, a polymer or copolymer having a sulfonic acid in the side chain, or polyacrylic acid; a water soluble metal salt such as zinc borate; a yellow dye; an amine salt; and so on, for hydrophilization treatment. The sol-gel treatment support disclosed in Japanese Patent O.P.I. Publication No. 5-304358, which has a functional group capable of causing addition reaction by radicals as a covalent bond, is suitably used.

### [Preparation of Light Sensitive Planographic Printing Plate Material]

In the invention, the above-described light sensitive layer coating liquid is coated on the support according to a conventional coating method, and dried to obtain a light sensitive planographic printing plate material.

Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method.

A drying temperature of the coated light sensitive layer is preferably from 60 to 160° C., more preferably from 80 to 140° C., and still more preferably from 90 to 120° C.

### [Preparation of Planographic Printing Plate]

The light sensitive planographic printing plate material of the invention is processed according to the following procedures to obtain a planographic printing plate. The planographic printing plate is mounted on an off-set printing press for printing.

### (Imagewise Exposure)

As a light source for recording an image on the light sensitive planographic printing plate material of the invention, a laser with an emission wavelength of from 350 to 450 nm, and preferably from 370 to 440 nm is preferably used.

Examples of light sources for imagewise exposure of the light sensitive planographic printing plate material include a He—Cd laser (441 nm), a combination of Cr:LiSAF and SHG crystals (430 nm) as a solid laser, and KnbO3, ring resonator (430 nm), AlGaInN (350-350 nm) or AlGaInN semiconductor laser (InGaN type semiconductor laser available on the market, 400-410 nm) as a semiconductor type laser.

When a laser is used for exposure, which can be condensed in the beam form, scanning exposure according to an image can be carried out, and direct writing is possible without using any mask material.

When the laser is employed for imagewise exposure, a highly dissolved image can be obtained, since it is easy to condense its exposure spot in minute size.

As a laser scanning method by means of a laser beam, there are a method of scanning on an outer surface of a cylinder, a method of scanning on an inner surface of a cylinder and a method of scanning on a plane. In the method of scanning on an outer surface of a cylinder, laser beam exposure is conducted while a drum around which a recording material is wound is rotated, in which main scanning is represented by the rotation of the drum, while sub-scanning is represented by the movement of the laser beam. In the method of scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of scanning on a plane, main scanning by means of a laser beam is carried out through a combination of a polygon mirror, a galvano mirror and an Fθ lens, and sub-scanning is carried out by moving a recording medium. The method of scanning on an outer surface of a cylinder and the method of scanning on an inner surface of a cylinder are suitable for high density image recording, since it is easier to increase accuracy of an optical system.

In the invention, imagewise exposure is carried out at a plate surface energy (an exposure energy at the surface of the planographic printing plate material) of from 10 to 500 mJ/cm², and more preferably from 10 to 300 mJ/cm². This exposure energy can be measured, employing a laser power meter PDGDO-3W produced by Ophir Optronics, Inc.

### (Developer)

In the manufacturing method of the invention of a planographic printing plate, the imagewise exposed light sensitive layer, which has been cured at exposed portions, is developed with an alkali developer, whereby the light sensitive layer at exposed portions are removed to form an image.

As such a developer, a conventional alkali aqueous solution is used. For example, there is an alkali developer containing an inorganic alkali agent such as sodium silicate, potassium silicate, ammonium silicate, sodium secondary phosphate, potassium secondary phosphate, ammonium secondary phosphate; sodium hydrogen carbonate, potassium hydrogen carbonate, ammonium hydrogen carbonate; sodium carbonate, potassium carbonate, ammonium carbonate; sodium borate, potassium borate, lithium borate; sodium hydroxide, potassium hydroxide, and ammonium hydroxide.

The alkali developer can contain organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents can be used singly or as a mixture of two or more thereof. The alkali developer can contain an anionic surfactant, an amphoteric surfactant, or an organic solvent such as alcohol.

The alkali developer can be prepared from a developing composition in the form of tablets or granules or a developer concentrate.

The developer concentrate may be prepared by forming a developer solution, followed by evaporation to dryness and is preferably prepared in such a manner that plural components are mixed with a small amount of water or without adding any water. The developer concentrate can also be prepared in the form of granules or tablets, as described in Japanese Patent O.P.I. Publication Nos. 51-61837, 2-109042, 2-109043, 3-39735, 5-142786, 6-266062 and 7-13341. The developer concentrate may be divided into plural parts differing in material species or compounding ratio.

The developer or developer replenisher in the invention can further contain an antiseptic agent, a coloring agent, a viscosity increasing agent, an antifoaming agent, or a water softener.

### (Automatic Developing Machine)

It is advantageous that an automatic developing machine is used in order to develop a light sensitive planographic printing plate material. It is preferred that the automatic developing machine is equipped with a means for automatically introducing a developer replenisher in a necessary amount into a developing bath, a means for discharging any excessive developer and a means for automatically introducing water in necessary amounts to the developing bath. It is preferred that the automatic developing machine comprises a means for detecting a planographic printing plate material to be transported, a means for calculating the area to be processed of the planographic printing plate material based on the detection, or a means for controlling a replenishing amount of a developer replenisher, a replenishing amount of water to be replenished or replenishing timing based on the detection and calculation. It is also preferred that the automatic developing machine comprises a means for controlling a temperature of a developer, a means for detecting a pH and/or electric conductivity of a developer, or a means for controlling a replenishing amount of the developer replenisher, a replenishing amount of water to be replenished and/or the replenishing timing based on the detected pH and/or electric conductivity. It is also preferred that the automatic developing machine have a function of diluting a developer concentrate with water and a function of stirring the diluted concentrate. Where developing is followed by washing, water used for washing can be reused as a dilution water for diluting the developer concentrate.

The automatic developing machine used in the invention may be provided with a pre-processing section to allow the plate to be immersed in a pre-processing solution prior to development. The pre-processing section is provided preferably with a mechanism of spraying a pre-processing solution onto the plate surface, preferably with a mechanism of controlling the pre-processing solution at a temperature within the range of 25 to 55° C., and preferably with a mechanism of rubbing the plate surface with a roller-type brush. Common water and the like are employed as the pre-processing solution.

### (Post-Processing)

The developed printing plate material is preferably subjected to post-processing. The post-processing step comprises post-processing the developed precursor with a post-processing solution such as washing water, a rinsing solution containing a surfactant, a finisher or a protective gumming solution containing gum arabic or starch derivatives as a main component. The post-processing step is carried out employing an appropriate combination of the post-processing solution described above. For example, a method is preferred in which a developed planographic printing plate precursor is post-washed with washing water, and then processed with a rinsing solution containing a surfactant, or a developed planographic printing plate precursor is post-washed with washing water, and then processed with a finisher, since it reduces fatigue of the rinsing solution or the finisher. It is preferred that a multi-step countercurrent processing is carried out employing a rinsing solution or a finisher.

The post-processing is carried out employing an automatic developing machine having a development section and a post-processing section. In the post-processing step, the developed printing plate is sprayed with the post-processing solution from a spray nozzle or is immersed into the post-processing solution in a post-processing tank. A method is known in which supplies a small amount of water onto the developed printing plate precursor to wash the precursor, and reuses the water used for washing as dilution water for developer concentrate. In the automatic developing machine, a method is applied in which each processing solution is replenished with the respective processing replenisher according to the area of the printing plate precursor to have been processed or the operating time of the machine. A method (use-and-discard method) can be applied in which the developed printing plate material is processed with fresh processing solution and discarded. The thus obtained planographic printing plate is mounted on a printing press, and printing is carried out.

### EXAMPLES

Next, the present invention will be explained in the following examples, but the present invention is not limited thereto. In the examples, “%” and “parts” represent “% by weight” and “parts by weight”, respectively, unless otherwise specified.

### Preparation of Support

A 0.3 mm thick aluminum plate (material 1050, quality H16) was degreased at 60° C. for one minute in a 5% sodium hydroxide solution, washed with waters immersed at 25° C. for one minute in 10% hydrochloric acid solution to neutralize, and then washed with water.

The resulting aluminum plate was electrolytically etched using an alternating current at 25° C. for 60 seconds at a current density of 100 A/dm² in a 0.3 weight % nitric acid solution, desmutted at 60° C. for 10 seconds in a 5% sodium hydroxide solution.

The desmutted aluminum plate was anodized at 25° C. for 1 minute at a current density of 10 A/dm² and at a voltage of 15 V in a 15% sulfuric acid solution, and further subjected to hydrophilization treatment at 75° C. in a 1% polyvinyl phosphonic acid solution. Thus, support was obtained.

The center line average surface roughness (Ra) of the support was 0.65 μm.

### [Preparation of Light Sensitive Planographic Printing Plate Material Samples]

The following light sensitive layer coating solution 1 was coated on the resulting support through a wire bar, and dried at 95° C. for 1.5 minutes to give a light sensitive layer having a coating amount of 1.5 g/m². Subsequently, the following oxygen shielding layer coating solution 1 was coated on the resulting light sensitive layer using a wire bar, and dried at 75° C. for 1.5 minutes to give an oxygen shielding layer with a coating amount of 1.5 g/m². Thus, light sensitive planographic printing plate material samples 101 through 142 were prepared.

(Light sensitive layer coating solution 1)

| | | |
|---|---|---|
| Reaction product (M1-15) of | 42.0 | parts |
| N-n-butyldiethanolamine (1 mole), 1,3-bis(1-cyanato-1- | | |
| methylethyl)benzene (2 moles) and 2-hydroxyethyl | | |
| methacrylate (2 moles) | | |
| Triethylene glycol dimethacrylate | 6.0 | parts |
| Copolymer of methacrylic acid and | 35.0 | parts |
| methyl methacrylate (25:75 by weight ratio) | | |
| with a molecular weight of 36000) | | |
| Sensitizing dye as shown in Table 1 | 4.0 | parts |
| 2,2′-Bis(2-chlorophenyl)- | 3.0 | parts |
| 4,5,4′,5′-tetraphenylbiimidazole | | |
| Compound represented by formula 1 | 0.3 | parts |
| as shown in Table 1 or Compound I, II or III | | |
| described below | | |
| N-Phenylglycine benzyl ester | 4.0 | parts |
| Phthalocyanine pigment | 3.5 | parts |
| (MHI 454 produced by Mikuni Sikisosha) | | |
| 2-t-Butyl-6-(3-t-butyl-2-hydroxy-5- | 0.2 | parts |
| methylbenzyl)-4-methylphenylacrylate | | |
| (Sumirizer GS: produced by Sumitomo 3M Co., Ltd.) | | |
| 2,4,6-Tris(dimethylaminomethyl)phenol | 1.0 | part |
| Bis(2,2,6,6-tetramethyl-4-piperidyl)sebacate | 0.1 | parts |
| Fluorine-contained surfactant | 0.5 | parts |
| (F-178K: produced by Dainippon Ink Co., Ltd.) | | |
| Siloxane surfactant | 0.9 | parts |
| (BYK337: produced by BYK CHEMIE Co., Ltd.) | | |
| Methyl ethyl ketone | 80 | parts |
| Propylene glycol methyl ether | 820 | parts |
| (Oxygen shielding layer coating solution 1) | | |
| Polyvinyl alcohol (Celvol 103: produced | 85.0 | parts |
| by Celanese Corporation) | | |
| Vinyl pyrrolidone-vinyl acetate copolymer | 15.0 | parts |
| (Luvitek VA64W, produced by BASF Inc.) | | |
| Surfinol 465 (produced by Air Products Inc.) | 0.2 | parts |
| Water | 900 | parts |

Light sensitive planographic printing plate material samples 143 through 148 as shown in Table 2 were prepared in the same manner as light sensitive planographic printing plate material samples 110 through 115 above, respectively, except that (η-cumene)(η-cyclopentadienyl) iron hexafluorophosphate was used instead of 2,2′-bis(2-chlorophenyl)-4,5,4′,5′-tetraphenylbiimidazole.

Light sensitive planographic printing plate material samples 149 through 154 as shown in Table 2 were prepared in the same manner as light sensitive planographic printing plate material samples 110 through 115 above, respectively, except that a reaction product of 2-(2-hydroxyethyl)piperidine (1 mole), 1,6-diisocyanatohexane (2 moles) and 2-hydroxyethyl methacrylate (2 moles) was used instead of the reaction product of N-n-butyldiethanolamine (1 mole), 1,3-bis(1-cyanato-1-methylethyl)benzene (2 moles) and 2-hydroxyethyl methacrylate (2 moles).

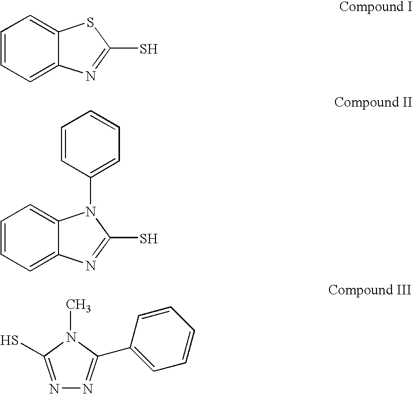

### [Evaluation of Light Sensitive Planographic Printing Plate Material Samples]

### (Sensitivity)

Each of the light sensitive planographic printing plate material samples obtained above was imagewise exposed at a resolving degree of 2400 dpi, employing a plate setter News CTP (produced by ECRM Co., Ltd.) equipped with a 405 nm light source with an output power of 60 mW). Herein, dpi represents the dot numbers per 2.54 cm.

The image pattern used for the exposure comprised a 100 % solid image, an uppercase alphabet, and a lowercase alphabet of reverse text, the alphabets having a font of Times New Roman and a point size of 3 to 10.

Subsequently, the exposed sample was subjected to development treatment employing a CTP automatic developing machine (Raptor Polymer produced by Glunz & Jensen Inc.) to obtain a planographic printing plate sample. Herein, the developing machine comprised a preheating section set at 105° C., a pre-washing section for removing the oxygen shielding layer before development, a development section set at 30° C. and charged with developer having the following developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate sample was obtained.

(Composition of developer and developer replenisher)

| | |
|---|---|
| Potassium silicate A | 8.0 parts |
| Newcol B-13SN (produced by | 3.0 parts |
| Nippon Nyukazai Co., Ltd.) | |
| Water | 89.0 parts |
| Potassium hydroxide | amount giving pH 12.5 |

The minimum exposure energy (μJ/cm²), at which no thickness reduction of the solid image layer of the resulting planographic printing plate sample obtained was observed, was defined as recording energy and evaluated as a measure of sensitivity. The less the recording energy is, the higher the sensitivity.

### (Storage Stability or Sensitivity Variation After Storage)

The planographic printing plate material sample obtained above was stored at 55° C. for three days in a thermostat. Sensitivity of the resulting sample was determined in the same manner as above, and the sensitivity ratio of sensitivity after storage to sensitivity before storage was determined and evaluated as a measure of storage stability. The closer to 100% the ratio is, the higher the storage stability.

### (Sludge Amount)

Employing the automatic developing machine above, twenty-five square meters per day of each sample exposed as above at exposure energy providing its sensitivity were subjected to development for one month (30 days) while supplying 50 ml per m² of sample of a developer replenisher. Thus, a fatigue developer was obtained with respect to each sample. One liter of the resulting fatigue developer was filtered with a filter paper No. 2 (produced by ADVANTEC Co., Ltd.) to obtain residue (sludge). The resulting residue was dried, and weighed as the sludge amount.

### (Contamination at Non-Image Portions)

Employing the automatic developing machine above, each sample exposed as above at exposure energy providing its sensitivity was developed with the above fatigue developer to obtain a planographic printing plate sample.

The resulting planographic printing plate sample was mounted on a press (DAIYA1F-1 produced by Mitsubishi Jukogyo Co., Ltd.), and printing was carried out, wherein a coat paper, printing ink (soybean ink, “Naturalith 100” produced by Dainippon Ink Kagaku Kogyo Co., Ltd.), and dampening water (SG-51, H solution produced by Tokyo Ink Co., Ltd., Concentration: 1.5%) were used. One hundred prints were printed, and contamination at non-image portions of the one hundredth print was observed visually or through a loupe, and evaluated according to the following criteria.
A: No contamination was observed.
B: Extremely slight contamination was observed through a loupe.
C: A little contamination was observed through a loupe, but was not practically problematic.
D: Some contamination was observed through a loupe, which was practically problematic.
E: Apparent contamination was visually observed, which was practically problematic.

### (Printing Durability)

The light sensitive planographic printing plate material sample was exposed at exposure energy of 50 μJ/cm², and developed to obtain a planographic printing plate sample. The resulting planographic printing plate sample was mounted on a press (DAIYA1F-1 produced by Mitsubishi Jukogyo Co., Ltd.), and printing was carried out, wherein a coat paper, printing ink (soybean ink, “Naturalith 100” produced by Dainippon Ink Kagaku Kogyo Co., Ltd.) and dampening water (SG-51, H solution produced by Tokyo Ink Co., Ltd., Concentration: 1.5%) were used. The number of prints printed until dot area reduction at highlight portions of print was observed was evaluated as a measure of printing durability.

The results are shown in Tables 1 and 2.

TABLE 1

| | Compound | | | | | Contamination | | |
|---|---|---|---|---|---|---|---|---|
| | represented by | | | Storage | Sludge | at | Printing | |
| Sample | formula 1 or | Sensitizing | Sensitivity | Stability | Amount | non-image | durability | |
| No. | Compound 1, 2 or 3 | dye | (mJ/cm²) | (%) | (g) | portions | (×1000) | Remarks |
| 101 | Compound 1 | 1 | 58 | 199 | 10.7 | D | 100 | Comp. |
| 102 | Compound 1 | 15 | 61 | 190 | 9.9 | D | 150 | Comp. |
| 103 | Compound 2 | 3 | 65 | 194 | 11 | D | 100 | Comp. |
| 104 | Compound 2 | 54 | 70 | 200 | 12.4 | D | 50 | Comp. |
| 105 | Compound 3 | 21 | 69 | 168 | 9.8 | D | 100 | Comp. |
| 106 | Compound 3 | 43 | 75 | 180 | 11.8 | D | 50 | Comp. |
| 107 | 3 | 21 | 13 | 110 | 1.2 | A | 400 | Inv. |
| 108 | 3 | 43 | 23 | 119 | 2.5 | A | 300 | Inv. |
| 109 | 3 | 53 | 21 | 130 | 3 | A | 300 | Inv. |
| 110 | 7 | 2 | 12 | 109 | 1.0 | A | 400 | Inv. |
| 111 | 7 | 15 | 10 | 105 | 1.1 | A | 400 | Inv. |
| 112 | 7 | 54 | 20 | 123 | 2.1 | A | 300 | Inv. |
| 113 | 7 | 59 | 18 | 120 | 2.2 | A | 400 | Inv. |
| 114 | 7 | 61 | 10 | 106 | 1.6 | A | 400 | Inv. |
| 115 | 7 | 74 | 11 | 108 | 1.9 | A | 400 | Inv. |
| 116 | 10 | 15 | 11 | 120 | 1.2 | A | 300 | Inv. |
| 117 | 10 | 52 | 19 | 125 | 2.8 | B | 300 | Inv. |
| 118 | 18 | 3 | 22 | 121 | 2.4 | A | 300 | Inv. |
| 119 | 18 | 31 | 18 | 126 | 1.9 | A | 300 | Inv. |
| 120 | 33 | 13 | 20 | 120 | 3.1 | A | 300 | Inv. |
| 121 | 33 | 21 | 14 | 112 | 2.7 | A | 300 | Inv. |
| 122 | 33 | 53 | 30 | 129 | 2.9 | A | 300 | Inv. |
| 123 | 33 | 62 | 10 | 109 | 1.7 | A | 400 | Inv. |
| 124 | 35 | 1 | 24 | 127 | 2.3 | A | 300 | Inv. |
| 125 | 35 | 15 | 12 | 115 | 1.1 | A | 400 | Inv. |
| 126 | 35 | 52 | 28 | 123 | 2 | B | 300 | Inv. |
| 127 | 35 | 61 | 11 | 107 | 1.5 | A | 400 | Inv. |
| 128 | 35 | 74 | 15 | 109 | 2 | A | 400 | Inv. |
| 129 | 42 | 13 | 22 | 121 | 3.2 | A | 300 | Inv. |
| 130 | 42 | 21 | 13 | 117 | 1.4 | A | 400 | Inv. |
| 131 | 44 | 2 | 25 | 126 | 2.8 | A | 300 | Inv. |
| 132 | 44 | 58 | 31 | 130 | 2.9 | A | 300 | Inv. |
| 133 | 47 | 10 | 18 | 129 | 2.3 | B | 300 | Inv. |
| 134 | 47 | 23 | 16 | 124 | 2.2 | A | 300 | Inv. |
| 135 | 57 | 15 | 12 | 114 | 1.3 | A | 300 | Inv. |
| 136 | 57 | 38 | 24 | 129 | 1.9 | B | 300 | Inv. |
| 137 | 58 | 16 | 20 | 126 | 2.5 | A | 300 | Inv. |
| 138 | 58 | 44 | 21 | 127 | 2 | A | 300 | Inv. |
| 139 | 62 | 15 | 13 | 115 | 1.2 | A | 300 | Inv. |
| 140 | 62 | 21 | 14 | 115 | 1.3 | A | 300 | Inv. |
| 141 | 65 | 1 | 28 | 128 | 2.6 | A | 300 | Inv. |
| 142 | 65 | 15 | 30 | 127 | 2.3 | A | 300 | Inv. |

Comp.: Comparative,
Inv.: Inventive

TABLE 2

| | | | | | | Contamination | | |
|---|---|---|---|---|---|---|---|---|
| | Compound | | | Storage | Sludge | at | Printing | |
| Sample | represented by | Sensitizing | Sensitivity | Stability | Amount | non-image | durability | |
| No. | formula 1 | dye | (mJ/cm²) | (%) | (g) | portions | (×1000) | Remarks |
| 143 | 7 | 2 | 14 | 114 | 1.7 | A | 400 | Inv. |
| 144 | 7 | 15 | 11 | 107 | 1.4 | A | 400 | Inv. |
| 145 | 7 | 54 | 23 | 124 | 1.8 | B | 300 | Inv. |
| 146 | 7 | 59 | 22 | 125 | 2.3 | A | 400 | Inv. |
| 147 | 7 | 61 | 12 | 109 | 1.9 | A | 400 | Inv. |
| 148 | 7 | 74 | 15 | 111 | 2.3 | A | 400 | Inv. |
| 149 | 7 | 2 | 13 | 109 | 1.6 | A | 400 | Inv. |
| 150 | 7 | 15 | 10 | 106 | 1.1 | A | 400 | Inv. |
| 151 | 7 | 54 | 21 | 126 | 2 | A | 300 | Inv. |
| 152 | 7 | 59 | 19 | 124 | 2.3 | A | 400 | Inv. |
| 153 | 7 | 61 | 10 | 105 | 1.6 | A | 400 | Inv. |
| 154 | 7 | 74 | 10 | 106 | 1.8 | A | 400 | Inv. |

Inv.: Inventive

As is apparent from Tables 1 and 2, inventive light sensitive planographic printing plate material samples 107 through 154 provide high sensitivity, excellent storage stability, high printing durability, minimized contaminations at non-image portions and minimized sludge produced during development, as compared with comparative light sensitive planographic printing plate material samples 101 through 106. Further, inventive light sensitive planographic printing plate material samples 110 through 115 employing a hexaarylbiimidazole compound as a polymerization initiator is superior to inventive light sensitive planographic printing plate material samples 143 through 148 employing an iron-arene complex as a polymerization initiator.

What is claimed is:

1. A light sensitive planographic printing plate material comprising a support and provided thereon, a light sensitive layer containing a photopolymerization initiator, a polymerizable ethylenically unsaturated compound, a sensitizing dye, a polymeric binder and a compound represented by formula 1, 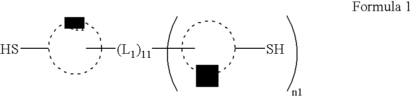
wherein Q₁₁ and Q₁₂ represent a non-metallic atomic group to form an unsaturated heterocyclic ring, provided that Q₁₁ and Q₁₂ may be the same or different; L₁ represents a divalent, trivalent or tetravalent linkage group; 11 is an integer of 0 or 1; and n1 is an integer of from 1 to 3.

2. The light sensitive planographic printing plate material of claim 1, wherein the compound represented by formula 1 is a compound represented by formula 2, 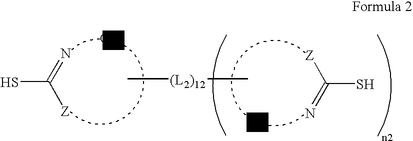
wherein Q₂₁ and Q₂₂ represent a non-metallic atomic group to form an unsaturated heterocyclic ring together with N═C—Z, provided that Q₂₁ and Q₂₂ may be the same or different; Z represents —CR₂₁═, —NR₂₂—, —S—, or —O—, in which R₂₁ and R₂₂ independently represent a hydrogen atom or a substituent; L₂ represents a divalent, trivalent or tetravalent linkage group; 12 is an integer of 0 or 1; and n2 is an integer of from 1 to 3.

3. The light sensitive planographic printing plate material of claim 1, wherein the compound represented by formula 1 is a compound represented by formula 3, 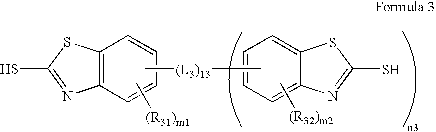
wherein R₃, and R₃₂ represent a substituent; m1 and m2 independently represent an integer of from 0 to 3; L₃ represents a divalent, trivalent or tetravalent linkage group; 13 is an integer of 0 or 1; and n3 is an integer of from 1 to 3.

4. The light sensitive planographic printing plate material of claim 1, wherein the sensitizing dye has a coumarin moiety, an-acridone moiety or a styryl moiety as the molecular nucleus.

5. The light sensitive planographic printing plate material of claim 1, wherein the polymerization initiator includes a hexaarylbiimidazole compound.

6. The light sensitive planographic printing plate material of claim 1, wherein the polymerizable ethylenically unsaturated compound is a reaction product of Compounds (C1), (C2) and (C3), Compound (C1) being a compound having in the molecule at least one ethylenic double bond and one hydroxyl group, Compound (C2) being a diisocyanate compound, and Compound (C3) being a diol compound having in the molecule a tertiary amino group or a compound having in the molecule one secondary amino group and one hydroxyl group.

7. The light sensitive planographic printing plate material of claim 1, wherein the polymerizable ethylenically unsaturated compound is a compound represented by formula 4, 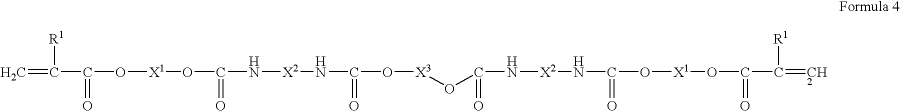
wherein R¹ represents a hydrogen atom or a methyl group; X¹ represents a divalent aliphatic hydrocarbon group; X² represents a divalent hydrocarbon radical containing an aromatic ring; and X³ represents a divalent linkage group containing a tertiary amino group.

8. The light sensitive planographic printing plate material of claim 1, wherein the content of the compound represented by formula 1 in the light sensitive layer is from 0.01 to 20% by weight, based on the total solid content of light sensitive layer.

9. The light sensitive planographic printing plate material of claim 1, wherein the content of the compound represented by formula 1 in the light sensitive layer is from 0.05 to 10% by weight, based on the total solid content of light sensitive layer.
